(19) United States
(12) Patent Application Publication
(10) Pub. No.: US 2026/0333459 A1
(43) Pub. Date: Oct. 22, 2026

(54) VIRTUAL IDENTIFIERS FOR SYNCHRONIZATION SIGNAL BLOCK TO RANDOM ACCESS CHANNEL OCCASION MAPPING

(71) Applicant: Lenovo (United States) Inc., Morrisville, NC (US)

(72) Inventors: Karthikeyan Ganesan, Nauheim (DE); Ravi Kuchibhotla, Chicago, IL (US)

(73) Assignee: Lenovo (United States) Inc., Morrisville, NC (US)

(21) Appl. No.: 19/562,417

(22) Filed: Mar. 10, 2026

(51) Int. Cl. H04W 74/0833; H04W 74/00

(52) U.S. Cl. CPC H04W 74/0833; H04W 74/004

(57) ABSTRACT

Various aspects of the present disclosure relate to virtual identifiers for synchronization signal block (SSB) to random access channel (RACH) occasion (RO) mapping. A user equipment (UE) may receive first signaling from a network equipment (NE) that indicates a first mapping between a set of SSB indices and a set of virtual identifiers. The UE may receive second signaling from the NE that indicates a second mapping between the set of virtual identifiers and a set of ROs. The UE may select an SSB index of the set of SSB indices, where the SSB index corresponds to a virtual identifier of the set of virtual identifiers based on the first mapping. The UE may transmit a RACH preamble to the NE during an RO of the set of ROs, where the RO corresponds to the virtual identifier based on the second mapping.

### TECHNICAL FIELD

The present disclosure relates to wireless communications, and more specifically to time-frequency resource management for the wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive first signaling that indicates a first mapping between a set of synchronization signal block (SSB) indices and a set of virtual identifiers, receive second signaling (e.g., different from the first signaling and/or the same as the first signaling) that indicates a second mapping between the set of virtual identifiers and a set of random access channel (RACH) occasions (ROs), select an SSB index of the set of SSB indices, where the SSB index corresponds to a virtual identifier of the set of virtual identifiers based on the first mapping, and transmit a RACH preamble during an RO of the set of ROs, where the RO corresponds to the virtual identifier based on the second mapping.

A processor (e.g., a standalone processor chipset, or a component of a UE) for wireless communication is described. The processor may be configured to, capable of, or operable to perform one or more operations as described herein. For example, the processor may be configured to, capable of, or operable to receive first signaling that indicates a first mapping between a set of SSB indices and a set of virtual identifiers, receive second signaling that indicates a second mapping between the set of virtual identifiers and a set of ROs, select an SSB index of the set of SSB indices, where the SSB index corresponds to a virtual identifier of the set of virtual identifiers based on the first mapping, and transmit a RACH preamble during an RO of the set of ROs, where the RO corresponds to the virtual identifier based on the second mapping.

A method performed or performable by a UE for wireless communication is described. The method may include receiving first signaling that indicates a first mapping between a set of SSB indices and a set of virtual identifiers, receiving second signaling that indicates a second mapping between the set of virtual identifiers and a set of ROs, selecting an SSB index of the set of SSB indices, where the SSB index corresponds to a virtual identifier of the set of virtual identifiers based on the first mapping, and transmitting a RACH preamble during an RO of the set of ROs, where the RO corresponds to the virtual identifier based on the second mapping.

In some implementations of the UE, the processor, and the method described herein, the UE, the processor, and the method may further be configured to, capable of, or operable to receive third signaling that suppresses a transmission associated with one or more SSB indices of the set of SSB indices, determine one or more first virtual identifiers corresponding to the one or more SSB indices based on the first mapping, determine one or more additional ROs of the set of ROs corresponding to the one or more first virtual identifiers based on the second mapping, and refrain from transmitting the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs. In some implementations, the UE, the processor, and the method may further be configured to, capable of, or operable to receive, prior to receiving the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and apply, based on the third signaling, an offset in a time domain to beam groups of the set of beam groups other than the beam group, where the beam groups are associated with contiguous transmission in the time domain based on the offset.

In some implementations, the one or more SSB indices are associated with a common spatial region. In some implementations, the third signaling includes a bitmap with at least one bit indicating to suppress the transmission associated with the beam group. In some implementations, the transmission includes a set of transmission types associated with the beam group, where the set of transmission types includes an SSB transmission type, a RACH transmission type, a system information transmission type, and a paging transmission type, and the UE, the processor, and the method may further be configured to, capable of, or operable to receive fifth signaling that indicates respective numerical quantities of time-frequency resources associated with the set of transmission types, where respective transmission types of the set of transmission types are grouped in the time domain based on the respective numerical quantities of the time-frequency resources.

In some implementations, to select the SSB index, the UE, the processor, and the method may be configured to, capable of, or operable to perform respective measurements associated with a set of beams, where the set of beams correspond to the set of SSB indices, and determine, based on the respective measurements, that a beam corresponding to the SSB index has a highest quality of the set of beams. In some implementations, the first signaling includes first radio resource control (RRC) signaling, and the second signaling includes at least one of the first RRC signaling, second RRC signaling, a medium access control-control element (MAC-CE), a downlink control information (DCI), or a wake-up signal (WUS). In some implementations, the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. In some implementations, the virtual identifier includes at least one of a virtual RACH occasion (VRO) identifier associated with one or more ROs of the set of ROs or a VRO-group (VRO-G) identifier associated with two or more ROs of the set of ROs. In some implementations, the virtual identifier includes the VRO-G identifier, and to transmit the RACH preamble, the UE, the processor, and the method may further be configured to, capable of, or operable to transmit a set of repetitions of the RACH preamble on the two or more ROs.

An NE (e.g., a base station) for wireless communication is described. The NE may be configured to, capable of, or operable to perform one or more operations as described herein. For example, the NE may be configured to, capable of, or operable to transmit first signaling that indicates a first mapping between a set of SSB indices and a set of virtual identifiers, transmit second signaling that indicates a second mapping between the set of virtual identifiers and a set of ROs, and receive a RACH preamble during an RO of the set of ROs, where the RO corresponds to a virtual identifier of the set of virtual identifiers based on the second mapping, and where the virtual identifier corresponds to an SSB index of the set of SSB indices based on the first mapping.

A processor (e.g., a standalone processor chipset, or a component of an NE) for wireless communication is described. The processor may be configured to, capable of, or operable to perform one or more operations as described herein. For example, the processor may be configured to, capable of, or operable to transmit first signaling that indicates a first mapping between a set of SSB indices and a set of virtual identifiers, transmit second signaling that indicates a second mapping between the set of virtual identifiers and a set of ROs, and receive a RACH preamble during an RO of the set of ROs, where the RO corresponds to a virtual identifier of the set of virtual identifiers based on the second mapping, and where the virtual identifier corresponds to an SSB index of the set of SSB indices based on the first mapping.

A method performed or performable by an NE (e.g., a base station) for wireless communication is described. The method may include transmitting first signaling that indicates a first mapping between a set of SSB indices and a set of virtual identifiers, transmitting second signaling that indicates a second mapping between the set of virtual identifiers and a set of ROs, and receiving a RACH preamble during an RO of the set of ROs, where the RO corresponds to a virtual identifier of the set of virtual identifiers based on the second mapping, and where the virtual identifier corresponds to an SSB index of the set of SSB indices based on the first mapping.

In some implementations of the NE, the processor, and the method described herein, the NE, the processor, and the method may further be configured to, capable of, or operable to determine to suppress a transmission associated with one or more SSB indices of the set of SSB indices, transmit third signaling that suppresses the transmission associated with the one or more SSB indices, determine one or more first virtual identifiers corresponding to the one or more SSB indices based on the first mapping, determine one or more additional ROs of the set of ROs corresponding to the one or more first virtual identifiers based on the second mapping, and refrain from monitoring for the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs.

In some implementations, the NE, the processor, and the method may further be configured to, capable of, or operable to transmit, prior to transmitting the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and apply, based on the third signaling, an offset in a time domain to beam groups of the set of beam groups other than the beam group, where the beam groups are associated with contiguous transmission in the time domain based on the offset. In some implementations, the one or more SSB indices are associated with a common spatial region. In some implementations, the third signaling includes a bitmap with at least one bit indicating to suppress the transmission associated with the beam group.

In some implementations, to determine whether to suppress the transmission, the NE, the processor, and the method may be configured to, capable of, or operable to determine, for the set of beam groups and over a measurement window, respective RACH loads including a numerical quantity of RACH preambles in a numerical quantity of available ROs, where the transmission is suppressed for the beam group based on a RACH load of the respective RACH loads associated with the beam group satisfying a threshold value. In some implementations, the NE, the processor, and the method may further be configured to, capable of, or operable to receive, from a UE associated with a spatial direction covered by the beam group, an additional RACH preamble on an additional beam group, and cancel suppression of the transmission for the beam group based on the additional RACH preamble. In some implementations, the NE, the processor, and the method may further be configured to, capable of, or operable to transmit, based on a periodicity, fifth signaling on an additional beam group associated with a spatial direction covered by the beam group, receive, in response to the fifth signaling, an additional RACH preamble, and cancel suppression of the transmission for the beam group based on the additional RACH preamble.

In some implementations, the transmission includes a set of transmission types associated with the beam group, where the set of transmission types includes an SSB transmission type, a RACH transmission type, a system information transmission type, and a paging transmission type, and the NE, the processor, and the method may further be configured to, capable of, or operable to transmit fifth signaling that indicates respective numerical quantities of time-frequency resources associated with the set of transmission types, where respective transmission types of the set of transmission types are grouped in the time domain based on the respective numerical quantities of the time-frequency resources. In some implementations, the NE, the processor, and the method may further be configured to, capable of, or operable to determine, based on the RO and the second mapping, the virtual identifier corresponding to the RO, determine, based on the virtual identifier and the first mapping, the SSB index corresponding to the virtual identifier, and transmit a random access response (RAR) on a beam corresponding to the SSB index.

In some implementations, the first signaling includes first RRC signaling, and the second signaling includes at least one of the first RRC signaling, second RRC signaling, a MAC-CE, a DCI, or a WUS. In some implementations, the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. In some implementations, the virtual identifier includes at least one of a VRO identifier associated with one or more ROs of the set of ROs or a VRO-G identifier associated with two or more ROs of the set of ROs. In some implementations, the virtual identifier includes the VRO-G identifier, and to receive the RACH preamble, the NE, the processor, and the method may further be configured to, capable of, or operable to transmit a set of repetitions of the RACH preamble on the two or more ROs.

### BRIEF DESCRIPTION OF THE DRAWINGS

FIG. 1 illustrates an example of a wireless communications system in accordance with aspects of the present disclosure.

FIGS. 2 and 3 illustrate examples of resource diagrams, in accordance with aspects of the present disclosure.

FIG. 4 illustrates an example of a wireless communications system, in accordance with aspects of the present disclosure.

FIG. 5 illustrates an example of a mapping configuration, in accordance with aspects of the present disclosure.

FIGS. 6 through 8 illustrate examples of transmission diagrams, in accordance with aspects of the present disclosure.

FIG. 9 illustrates an example of a signaling diagram, in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method performed by a UE in accordance with aspects of the present disclosure.

FIG. 14 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, the NE may transmit one or more SSBs that include one or more synchronization signals to enable UEs to synchronize with the NE and to perform initial access procedures, such as a random access procedure. The UE may perform the random access procedure to establish or reestablish a connection with the NE. For example, the UE transmits a RACH preamble on (e.g., during) one or more ROs that are mapped to the SSBs via an SSB-to-RO mapping. In some cases, if a traffic load of RACH-related signaling is relatively low (e.g., less than a threshold numerical quantity of RACH-related signaling) in one or more spatial directions, then the NE may suppress (e.g., mute) transmissions for one or more SSBs and/or one or more beam groups directed in the spatial directions to reduce power consumption. If the NE suppresses transmissions for the SSBs and/or beam groups, then the ROs allocated to the SSBs and/or beam groups may be unused, resulting in inefficient resource utilization at the NE and the UE. In some cases, the NE may transmit additional signaling to reconfigure the SSB-to-RO mapping to reallocate the ROs to other SSBs and/or beam groups (e.g., that are not suppressed). However, the additional signaling may increase signaling overhead and complexity.

As described herein, to improve efficiency of resource utilization, as well as to reduce signaling overhead and complexity, an NE and a UE may implement a virtual identifier abstraction layer between SSB indices corresponding to the SSBs and the ROs to provide for dynamically reallocating ROs to other SSBs and/or beam groups without updating an SSB-to-RO mapping. For example, the NE may transmit signaling (e.g., RRC signaling) to a UE that indicates a first mapping between a set of SSB indices and a set of virtual identifiers. The NE may also transmit second signaling (e.g., RRC signaling, a MAC-CE, DCI, or a WUS) to the UE that indicates a second mapping between the set of virtual identifiers and a set of ROs. The virtual identifiers provide the virtual identifier abstraction layer between the SSB indices and the ROs. The UE may select an SSB index that is mapped to a virtual identifier using the first mapping, and transmit a RACH preamble during an RO that is mapped to the virtual identifier using the second mapping. If the NE determines to suppress transmissions for one or more SSB indices (e.g., based on a traffic load of RACH-related signaling satisfying a threshold value), then the NE may transmit third signaling that suppresses the transmission for the SSB indices. The third signaling triggers deactivation of the second mapping between virtual identifiers that are mapped to the SSB indices and associated ROs. The ROs may then be dynamically reallocated to other SSBs and/or beam groups without updating the first mapping between SSB indices and virtual identifiers.

By performing the described techniques, a device (e.g., a UE and/or an NE) in a wireless communications system may provide for improved resource utilization, reduced signaling overhead, and enhanced network efficiency during random access procedures. The virtual identifier abstraction layer enables the NE to suppress transmissions for one or more SSB indices and/or beam groups (e.g., in response to low traffic load in spatial directions), while dynamically reallocating the corresponding ROs to other SSBs and/or beam groups without updating the first mapping between SSB indices and virtual identifiers. For example, the NE may reconfigure and/or update the second mapping via lower-layer signaling (e.g., a MAC-CE, DCI, and/or WUS), such that the NE may dynamically reallocate ROs with reduced signaling overhead compared to reconfiguring a direct SSB-to-RO mapping via RRC signaling. The virtual identifier abstraction layer reduces power consumption at the NE by enabling suppression of transmissions in spatial directions with relatively low traffic load, while maintaining efficient resource utilization by reallocating unused ROs to active SSBs and/or beam groups.

Reference is made herein to communicating data or information, such as signaling, communication resources, and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

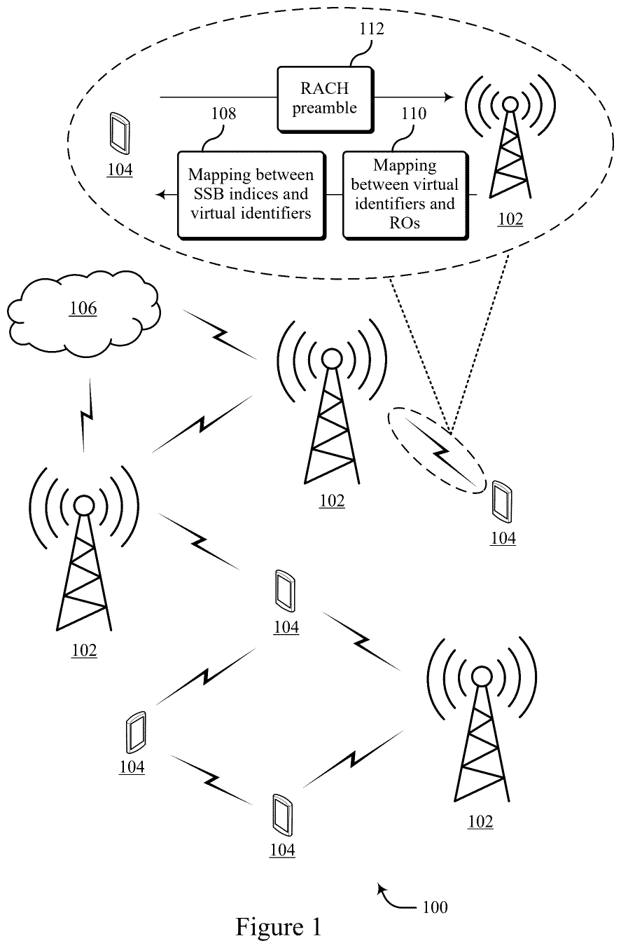

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology, including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be, or include, or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include, or may be referred to as, a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, the NEs 102 and the UEs 104 may consume energy to perform various operations (e.g., wireless communications, signal processing, data transmission, data reception). In some cases, the NEs 102 and the UEs 104 may support energy saving techniques to reduce power consumption, such as discontinuous transmission (DTX), discontinuous reception (DRX), or sleep modes. For example, an NE 102 and/or a UE 104 may enter an inactive state (e.g., low-power state, sleep state, idle state) if there is no downlink transmission or uplink reception, and may transition to an active state (e.g., may wake up) if transmission or reception is to be performed. An inactive state may refer to a power state in which a device reduces or suspends operation of one or more components to conserve energy. During a transition from an active state to an inactive state, the device may deactivate or power down various components, such as power amplifiers, radio frequency chains, baseband processing units, or other circuitry that is not utilized in the inactive state. For DTX, a device (e.g., the NE 102 or the UE 104) refrains from transmitting signals during periods with no data to transmit, providing for the device to reduce power consumption by deactivating or reducing power to transmitter components during inactive periods. For DRX, the device monitors for incoming signals during configured active periods and enters an inactive state during configured inactive periods, providing for the device to reduce power consumption by deactivating or reducing power to receiver components if reception is not expected.

In some cases, the NEs 102 may support multiple power states for network energy saving. Table 1 illustrates an example of power states of an NE power consumption model. The power states may include a deep sleep state, a light sleep state, a micro sleep state, an active downlink state, and an active uplink state. Each power state may include a characteristic, a relative power, P, an additional transition energy, E, and a total transition time, T. The relative power levels may include P1 for the deep sleep state, P2 for the light sleep state, P3 for the micro sleep state, P4 for the active downlink state, and P5 for the active uplink state, where P1 is less than P2, P2 is less than P3, and P3 is less than P4 and P5. The transition energy levels may include E1 for transitioning from the deep sleep state, E2 for transitioning from the light sleep state, and E3 for transitioning from the micro sleep state, where E1 is greater than E2, and E2 is greater than E3. Table 2 illustrates examples of relative power values, P, for reference configuration sets 1, 2, and 3 across different NE categories. The relative power values may vary depending on the NE category and the reference configuration set, with deep sleep having the lowest relative power consumption and active downlink having the highest relative power consumption.

TABLE 1
Power states of NE power consumption model

| | | | Additional | Total |
|---|---|---|---|---|
| | | Relative | transition | transition |
| Power state | Characteristic | Power P | energy² E | time T |
| Deep sleep¹ | There is neither downlink | P1 | E1 | T1 |
| | transmission nor uplink reception. | | | |
| | Time interval for the sleep should be | | | |
| | larger than the total transition time | | | |
| | entering and leaving this state. | | | |
| Light sleep | There is neither downlink | P2 | E2 | T2 |
| | transmission nor uplink reception. | | | |
| | Time interval for the sleep should be | | | |
| | larger than the total transition time | | | |
| | entering and leaving this state. | | | |
| Micro sleep | There is neither downlink | P3 | 0 | 0 |
| | transmission nor uplink reception. | | | |
| | Immediate transition is assumed for | | | |
| | network energy saving from or to a | | | |
| | non-sleep state. | | | |
| Active downlink | There is downlink transmission. | P4 | N.A. | |
| Active uplink | There is uplink reception. | P5 | | |

Note¹
Depending on implementations, there could be a state that the power is lower than deep sleep and utilizes a larger total transition time, e.g., hibernating sleep or Quasi-off.
Note²
Unit in relative power times duration.

TABLE 2
Relative power values P for reference
configuration set 1, set 2 and set 3

| | NE Category 1 | | | NE Category 2 | | |
|---|---|---|---|---|---|---|
| Power state | Set 1 | Set 2 | Set 3 | Set 1 | Set 2 | Set 3 |
| Deep sleep | 1 | | | 1 | | |
| Light sleep | 25 | | | 2.1 | | |
| Micro sleep | 55 | 50 | 38 | 5.5 | 5 | 3 |
| Active downlink | 280 | 200 | 152 | 32 | 26 | 17.6 |
| Active uplink | 110 | 90 | 80 | 6.5 | 5.8 | 4.2 |

Data traffic in the wireless communications system 100 may increase over time, such as by approximately 6.4 gigabytes (GB) per user per month. Operators of the wireless communications system 100 may implement energy-saving techniques due to the increased data traffic, rising overhead of spectrum (e.g., the range of radio frequencies allocated for wireless communication), capital investment, and ongoing RAN maintenance and upgrades, among other factors. In some cases, 5G use cases and the adoption of millimeter wave (mm-Wave) frequencies, which operate in the frequency range of approximately 24 GHz to 100 GHz and enable high-bandwidth communication, utilize an increased numerical quantity of sites and antennas when compared with previous use cases (e.g., 4G, LTE). Additionally, or alternatively, as wireless communications systems (e.g., including the wireless communications system 100) implement 5G across industries and geographical areas, handling more advanced services and applications utilizing relatively high data rates (e.g., extended reality (XR) applications), networks become denser, use more antennas, larger bandwidths, and more frequency bands. The increased numerical quantity of sites and antennas, as well as the increased data rates, may lead to increased energy consumption and emissions. Thus, the wireless communications system 100 may implement network energy saving (e.g., energy saving at one or more NEs 102 or other network-related devices) to reduce environmental impact through decreased greenhouse gas emissions, as well as to achieve operational cost savings.

The RAN consumes a relatively high amount of energy (e.g., greater than a threshold amount of energy), such as from one or more active antenna units (AAUs), which integrate antenna elements with radio frequency components in a single unit. The power consumption of the RAN can be split into two portions, including a dynamic portion, which the network consumes when data transmission or reception occurs, and a static portion, which the network consumes continuously to maintain operation of the radio access devices, even when data transmission or reception does not occur. The wireless communications system 100 may implement the network energy savings techniques to achieve more efficient operation dynamically and/or semi-statically and finer granularity adaptation of transmissions and/or receptions in time, frequency, spatial, and power domains. The network energy savings techniques may support feedback from one or more UEs 104, UE assistance information, and/or information exchange or coordination over network interfaces.

In some examples, the network energy savings techniques include configuring common channels within an active duration (e.g., time) of a cell. A cell may refer to a logical entity associated with an NE 102 that provides wireless communication services to one or more UEs 104 within a geographic coverage area. The cell may be associated with one or more defined (e.g., configured) radio resources, including time resources, frequency resources, and/or spatial resources (e.g., beams), that the NE 102 manages for communication with the UEs 104. If the NE 102 activates a network energy saving configuration for a cell, then common channels may be transmitted within an active time of the NE 102 to save power. For example, if an NE 102 activates the network energy saving configuration, such as an idle mode cell discontinuous transmission/discontinuous reception (DTX/DRX) configuration, then the common channels are to be transmitted within the active time of the NE 102 to save power. Otherwise, the NE 102 may consolidate or cluster the common channel frame to provide for the NE 102 to enter an inactive state (e.g., a deep sleep state, a sleep state) as part of the network energy savings.

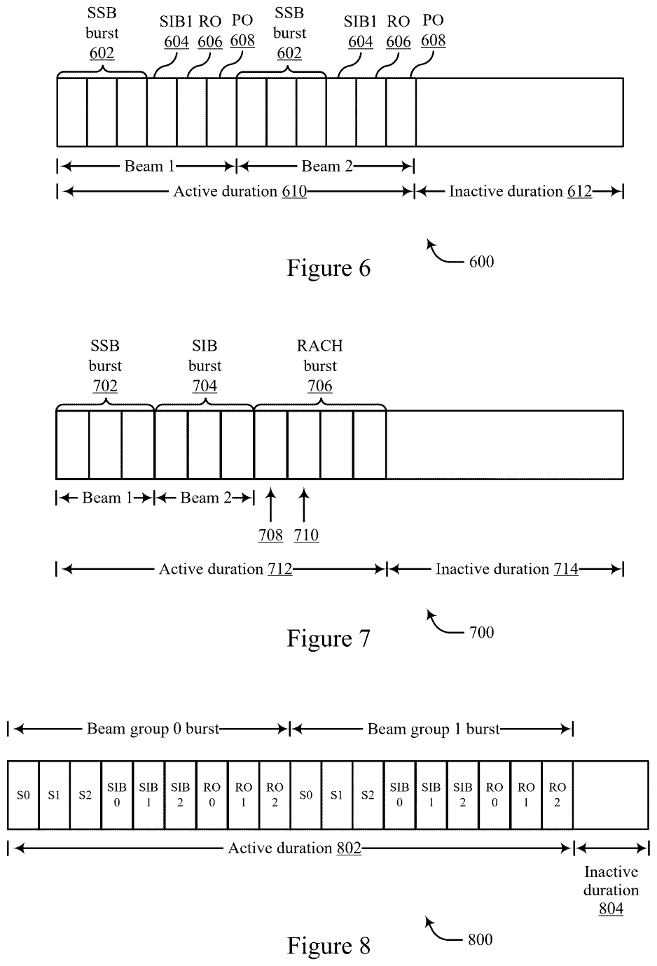

The common channels may include channels and/or signals that carry information accessible to multiple UEs 104, such as an SSB, an SIB, a paging channel, and/or a physical RACH (PRACH). The SSB may include a primary synchronization signal (PSS), a secondary synchronization signal (SSS), and a physical broadcast channel (PBCH), which enable UEs 104 to synchronize with the NE 102 and obtain initial system information. The SIB may include system information block type 1 (SIB1), which provides system information for initial access, as well as other SIB types that provide additional configuration information. The paging channel may include one or more POs, which are examples of defined time-frequency resources during which the NE 102 transmits paging messages to notify UEs 104 of incoming signaling (e.g., data and/or control information). The PRACH may include one or more ROs during which UEs 104 transmit RACH preambles to initiate random access procedures. In some cases, the common channels may be clustered in the time domain to improve power efficiency at the NE 102 and/or the UE 104. Clustering refers to grouping transmissions of common channels into concentrated time periods, followed by inactive durations during which the NE 102 and/or the UE 104 may enter a low-power state. In some cases, the clustering may be performed on a per-beam basis, where common channels associated with a single beam (e.g., SSB, SIB, RO, and PO for a beam) are grouped together in time before proceeding to common channels for a next beam, which is described in further detail with respect to FIG. 6. Additionally, or alternatively, the clustering may be performed on a per-burst basis, where common channels of the same type across multiple beams are grouped together (e.g., an SSB burst containing SSBs for multiple beams, followed by a SIB burst containing SIBs for multiple beams, followed by a RACH burst containing ROs for multiple beams), which is described in further detail with respect to FIG. 7. In some examples, the clustering may be performed using a hierarchical approach with beam groups, where beams associated with similar spatial directions are grouped together, and common channels for each beam group are clustered in time before proceeding to a next beam group, which is described in further detail with respect to FIG. 8.

In some examples, a UE 104 and/or an NE 102 may perform a random access procedure to establish or reestablish a connection between the UE 104 and the NE 102. For example, the UE 104 and/or the NE 102 may initiate the random access procedure for initial access, handover between cells, transition from an idle or inactive state to a connected state, recovery from a radio link failure, scheduling request when no dedicated scheduling request resources are available, beam failure recovery, and/or other procedures, including positioning or timing advance adjustment. The random access procedure may include multiple messages exchanged between the UE 104 and the NE 102. In a four-step random access procedure, the UE 104 transmits a RACH preamble (Msg1) on an RO, and the NE 102 responds with an RAR (Msg2) that includes timing advance information, an uplink grant for subsequent transmission, and a temporary cell radio network temporary identifier (C-RNTI). The UE 104 then transmits a scheduled transmission (Msg3) using the uplink grant provided in the RAR, which may include a connection request, identity information, and/or other control information depending on the purpose of the random access procedure. The NE 102 responds with a contention resolution message (Msg4) that resolves contention between UEs 104 that may have transmitted a same preamble on a same RO. In a two-step random access procedure, the UE 104 combines the RACH preamble and the scheduled transmission into a single message (MsgA), and the NE 102 responds with a combined RAR and contention resolution message (MsgB).

The UE 104 may determine an RO to use for transmitting the RACH preamble using a mapping between SSBs and ROs. For example, an NE 102 and/or a UE 104 may implement an SSB-to-RO mapping that defines a relationship between SSB indices and the ROs on which UEs 104 may transmit RACH preambles. The UE 104 may detect one or more SSBs transmitted by the NE 102, where each SSB is associated with an SSB index that identifies the beam direction of the SSB transmission. The UE 104 may perform one or more measurements on the detected SSBs to select a beam with a corresponding SSB index for communication. For example, the UE 104 may perform one or more of reference signal received power (RSRP) measurements, reference signal received quality (RSRQ) measurements, and/or signal-to-interference-plus-noise ratio (SINR) measurements, among other example measurements, on the detected SSBs. The RSRP measurement indicates the average power of resource elements carrying the SSB, providing an indication of signal strength for each beam. The RSRQ measurement indicates the quality of the received signal relative to interference and noise, providing an indication of signal quality for each beam. The SINR measurement indicates the ratio of signal power to interference and noise power, providing an indication of the channel conditions for each beam. The UE 104 may compare the measurements for each of the SSBs to select an SSB index corresponding to a beam that has a highest quality among the detected beams, such as a beam with a highest RSRP value, a highest RSRQ value, and/or a highest SINR value. In some cases, the UE 104 may select the beam using a combination of measurements, such as selecting a beam that satisfies threshold values for multiple measurement types.

The UE 104 may use the mapping to determine one or more ROs mapped to the selected SSB index. For example, the UE 104 may receive configuration information from the NE 102 that indicates the SSB-to-RO mapping, such as via system information (e.g., SIB1) or dedicated RRC signaling. The configuration information may indicate parameters, including a numerical quantity of SSBs mapped to each RO, a numerical quantity of ROs in the frequency domain, and/or a numerical quantity of ROs in the time domain. The UE 104 may use the selected SSB index and the configured mapping parameters to calculate an RO or set of ROs for the selected SSB index by applying the mapping rules in a defined order, such as first mapping preambles within an RO, then mapping frequency domain ROs, and then mapping time domain ROs to the SSB indices. The UE 104 then transmits the RACH preamble on the determined ROs (e.g., indicated by the mapping). The NE 102 receives the RACH preamble on the RO and uses the SSB-to-RO mapping to determine the beam direction (e.g., and corresponding SSB index) from which the UE 104 transmitted the RACH preamble according to the RO on which the preamble was received.

The SSB-RO association mapping configuration may follow various rules for mapping RACH preambles and ROs to SSBs. In some examples, the rules may include an NE 102 first mapping RACH preambles within ROs to SSBs, then mapping frequency domain ROs to the SSBs, and finally mapping the time domain ROs to SSBs. The mapping may proceed in increasing order of preamble indexes within a single RO. Additionally, or alternatively, the mapping proceeds in increasing order of frequency resource indexes for frequency multiplexed ROs. Additionally, or alternatively, the mapping proceeds in increasing order of time resource indexes for time multiplexed ROs within a PRACH slot. Additionally, or alternatively, the mapping proceeds in increasing order of indexes for PRACH slots.

In some examples, one or more parameters may define the mapping between SSB and ROs. For example, two RRC parameters define the mapping between SSB and ROs. The first RRC parameter, msg1-FDM, may have a value from a set (e.g., 1, 2, 4, 8). The second RRC parameter, ssb-perRACH-OccasionAndCB-PreamblesPerSSB, may have a value from a different set (e.g., ⅛, ¼, ½, 1, 2, 4, 8, 16). The msg1-FDM parameter indicates how many ROs the NE 102 allocates in the frequency domain at the same location in the time domain. The ssb-perRACH-OccasionAndCB-PreamblesPerSSB parameter indicates how many SSBs the NE 102 can map to one RO and how many preamble indexes the NE 102 can map to a single SSB. The ssb-perRACH-OccasionAndCB-PreamblesPerSSB parameter includes multiple portions (e.g., a CHOICE portion and an ENUMERATED portion). The CHOICE portion conveys information about a numerical quantity of SSBs per RO, where a value of oneEighth corresponds to one SSB associated with 8 ROs, a value of oneFourth corresponds to one SSB associated with 4 ROs, and so on. The ENUMERATED portion indicates a numerical quantity of contention-based preambles per SSB, where a value of n4 corresponds to 4 contention-based preambles per SSB, a value of n8 corresponds to 8 contention-based preambles per SSB, and so on.

Contention-based random access refers to a random access procedure in which multiple UEs 104 may select the same preamble, potentially causing collisions that the NE 102 resolves through subsequent messaging. The total number of contention-based preambles in an RO equals CB-preambles-per-SSB multiplied by max (1, SSB-per-rach-occasion), where a value of SSB-per-rach-occasion may be configured and/or defined. Various values of the ssb-perRACH-OccasionAndCB-PreamblesPerSSB parameter may indicate different numerical quantities of SSBs associated with an RO. For example, a value of 4 may correspond to 4 SSBs associated with an RO. In some cases, the msg1-FDM parameter may indicate a number of PRACH transmission occasions that the network frequency division multiplexes in one time instance. For example, the msg1-FDM parameter may have possible values of 1, 2, 4, or 8.

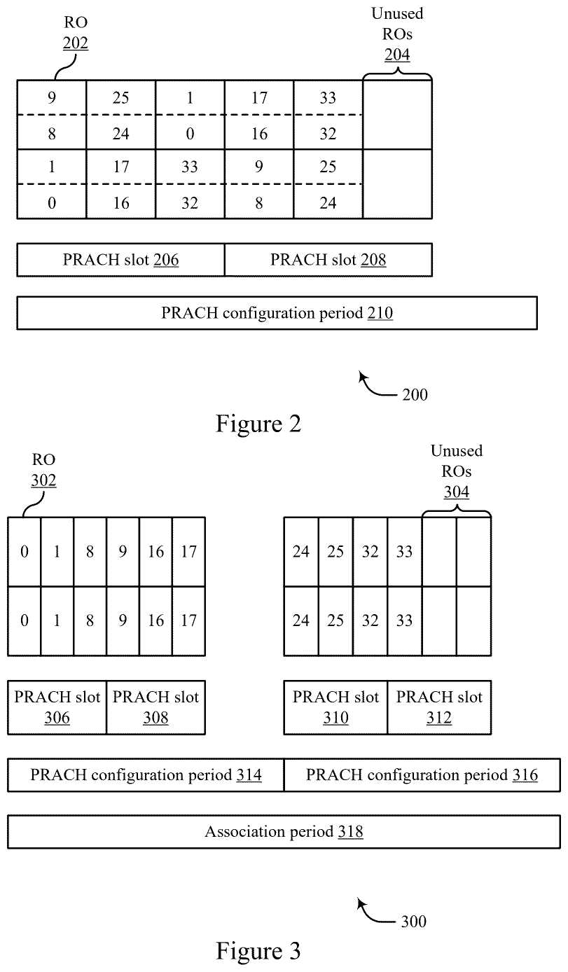

In addition to the RRC parameters, various numerical quantities of preambles may be available. In some cases, such as 5G NR, a total number of available preambles may equal 64. However, the actual preamble availability may depend on a zero correlation zone configuration and a root sequence index. The zero correlation zone may refer to a region in the time-frequency domain where different preamble sequences maintain orthogonality, enabling a receiver to distinguish between the preamble sequences. The root sequence index may indicate a base Zadoff-Chu sequence from which the NE 102 derives the preambles. In some examples, the NE 102 may associate SSBs (e.g., synchronization signal/PBCH (SS/PBCH) blocks) with ROs using the RRC parameters and mapping rules, which are described in further detail with respect to FIGS. 2 and 3.

The UE 104 and/or the NE 102 using the RRC parameters and mapping rules to select ROs for a random access procedure may present a drawback if the NE 102 adapts the PRACH to save energy (e.g., clustering common channels for network energy saving). Additionally, or alternatively, distribution of UEs across a cell or across beams in a cell may not remain uniform. Therefore, the NE 102 may adapt PRACH resources both in the time domain and in the spatial domain. Spatial domain adaptation may refer to selectively activating or deactivating beams pointing in different directions based on UE 104 distribution and traffic demand. The adaptation of PRACH resources may impact the SSB-to-RO mapping, resulting in modifications to the SSB-to-RO mapping configuration as the NE 102 adapts the PRACH resource allocation.

In some cases, the NE 102 may adapt or mute transmissions for SSBs within an SSB burst, which may impact the SSB-to-RO mapping. An SSB burst may refer to a set of SSB transmissions that occur within a defined time window, with each SSB transmitted on a different beam direction. The NE 102 may adapt transmissions by dynamically adjusting transmission parameters or resource allocations in response to changing network conditions, where the NE 102 modifies the configuration of SSB transmissions, RO allocations, or other common channel resources based on factors such as traffic demand, UE distribution, or energy saving objectives. For example, the NE 102 may adapt transmissions by reducing a numerical quantity of SSBs transmitted within an SSB burst, changing the periodicity of SSB transmissions, or modifying the beam directions associated with SSB transmissions based on traffic load or UE distribution. The UE 104 may reconfigure reception and transmission behavior according to updated configuration information received from the NE 102, such as adjusting the SSB-to-RO mapping or modifying the set of ROs on which the UE 104 may transmit RACH preambles.

Muting may refer to temporarily disabling transmission of signals on one or more beams or time-frequency resources to reduce power consumption. The muting may be temporary in that the NE 102 may cancel suppression of the transmission for the SSBs after a duration (e.g., triggered by signaling or upon expiration of a timer). In some cases, the NE 102 and/or the UE 104 may apply the muting to suppress the transmission for the SSBs for a muting period, which may be a timer value configured by the NE 102. The NE 102 resumes transmissions for the suppressed SSB indices and/or beam groups upon expiration of the timer. The NE 102 deactivates transmitter components associated with the muted beams during the muting period. For example, the NE 102 may mute transmissions for SSBs by suppressing transmissions for one or more beam directions corresponding to the SSBs, such that the NE 102 refrains from transmitting on the muted beams for a duration. The NE 102 may transmit signaling to the UE 104 indicating which SSBs are muted, such as via a bitmap in system information or dedicated signaling, where each bit corresponds to an SSB index and indicates whether the corresponding SSB transmission is active or suppressed. The UE 104 may refrain from monitoring (e.g., cancel monitoring, not monitor) for SSBs or transmitting RACH preambles on ROs associated with muted beams. In some cases, muting ROs may utilize additional signaling that the NE 102 transmits and the UE 104 processes, thereby impacting energy consumption at the NE 102 and the UE 104.

In some examples, the NE 102 may adapt a numerical quantity of SSBs that the NE 102 monitors for corresponding ROs (e.g., adapt uneven numbers of ROs per SSB and adapt uneven numbers of preambles per RO per SSB). However, adapting the numerical quantity of SSBs that the NE 102 monitors may result in inefficient resource utilization when SSBs are suppressed because the ROs allocated to the suppressed SSBs remain unused, and reconfiguring the SSB-to-RO mapping to reallocate the ROs may increase signaling overhead and complexity. For example, if the NE 102 suppresses transmissions for one or more SSBs to reduce power consumption (e.g., in spatial directions with relatively low traffic load), then the direct SSB-to-RO mapping results in the corresponding ROs being unused and unavailable for use by other SSBs or beam groups. The unused ROs represent wasted time-frequency resources that could otherwise be utilized to support RACH transmissions for active SSBs. Additionally, or alternatively, to reallocate the unused ROs to other SSBs, the NE 102 may transmit RRC signaling to reconfigure the SSB-to-RO mapping, which introduces latency and signaling overhead. The RRC signaling may result in the UE 104 performing a reconfiguration procedure, which may disrupt ongoing operations and increase processing complexity at the UE 104. Additionally, or alternatively, the direct coupling between SSB indices and physical ROs in the SSB-to-RO mapping limits the flexibility of the NE 102 to dynamically adapt RACH resources in response to changing traffic conditions or network energy saving techniques without incurring the overhead of reconfiguring the mapping via higher-layer signaling.

According to implementations, one or more of the NEs 102 and the UEs 104 are operable to implement various aspects of the techniques described with reference to the present disclosure. An NE 102 (e.g., a base station, gNB) transmits first signaling to a UE 104 that indicates a mapping between SSB indices and virtual identifiers 108. The NE 102 also transmits second signaling that indicates a mapping between virtual identifiers and ROs 110. The virtual identifiers represent an abstraction layer that decouples the SSB indices from the physical ROs, enabling dynamic reallocation of ROs without modifying the SSB-to-virtual-identifier mapping. For example, the UE 104 selects an SSB index that maps to a virtual identifier using the mapping between SSB indices and virtual identifiers 108. The UE 104 transmits a RACH preamble 112 during an RO that is mapped to the selected virtual identifier using the mapping between virtual identifiers and ROs 110. The NE 102 receives the RACH preamble 112 during the RO and determines the virtual identifier that is mapped to the RO using the mapping between virtual identifiers and ROs 110. The NE 102 then determines the SSB index that is mapped to the virtual identifier using the mapping between SSB indices and virtual identifiers 108.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a resource diagram 200 in accordance with aspects of the present disclosure. In some examples, the resource diagram 200 implements or is implemented by aspects of the wireless communications system 100. For example, the resource diagram 200 may be implemented by one or more UEs and/or NEs, which may be an example of NEs 102 and UEs 104, as described with reference to FIG. 1. The resource diagram 200 illustrates an example of SSB-to-RO mapping with multiple SSBs mapped to each RO within a PRACH configuration period.

The resource diagram 200 includes ROs 202 arranged in time and frequency domains, such as ten ROs 202 and two unused ROs 204. The ROs 202 include time-frequency resources allocated for RACH transmissions, as described with reference to FIG. 1. For example, the ROs 202 may be used by UEs to transmit RACH preambles during random access procedures. A UE may select an SSB index based on beam measurements and determine a corresponding RO 202 using the SSB-to-RO mapping. The UE may then transmit a RACH preamble on the determined RO 202 to initiate communication with an NE. The NE may monitor the ROs 202 to detect RACH preambles transmitted by UEs and may use the SSB-to-RO mapping to determine the beam direction from which a UE transmitted the RACH preamble based on the RO 202 on which the preamble was received.

In some examples, the resource diagram 200 includes one or more (e.g., two) unused ROs 204, which represent ROs that are not mapped to any SSB indices. The resource diagram 200 includes one or more PRACH slots, such as the PRACH slot 206 and PRACH slot 208. A PRACH slot may be an example of time-domain resources (e.g., in units of slots) allocated for PRACH transmissions. The PRACH slot 206 and PRACH slot 208 may be within a PRACH configuration period 210, which may be greater than a duration of the PRACH slot 206 and the PRACH slot 208. The PRACH configuration period 210 is a time period over which PRACH resources are configured. For example, a number of SSBs indicated to the UE 104 as being transmitted may equal ten (e.g., NSSB Tx=10). The transmitted SSBs may have indices {0, 1, 8, 9, 16, 17, 24, 25, 32, 33}. A number of SSBs mapped to one RO may equal two (e.g., N=2). A number of frequency division multiplexed ROs may equal two. A number of time-domain ROs in one PRACH slot may equal three. A number of PRACH slots in one PRACH configuration period may equal two. The resource diagram 200 displays numerical values representing SSB indices mapped to respective ROs 202, with values including 0, 1, 8, 9, 16, 17, 24, 25, 32, and 33 distributed across the ROs 202.

FIG. 3 illustrates an example of a resource diagram 300 in accordance with aspects of the present disclosure. In some examples, the resource diagram 300 implements or is implemented by aspects of the wireless communications system 100 and/or the resource diagram 200. For example, the resource diagram 300 may be implemented by one or more UEs and/or NEs, which may be an example of NEs 102 and UEs 104, as described with reference to FIG. 1. The resource diagram 300 illustrates an example of an SSB-to-RO mapping with a different SSB-to-RO ratio than the resource diagram 200.

The resource diagram 300 includes ROs 302 and unused ROs 304 in time and frequency domains, such as twenty ROs 302 and four unused ROs 304. The ROs 302 include time-frequency resources allocated for RACH transmissions, as described with reference to FIG. 1. For example, the ROs 302 may be used by UEs to transmit RACH preambles during random access procedures. A UE may select an SSB index based on beam measurements and determine a corresponding RO 302 using the SSB-to-RO mapping. The UE may then transmit a RACH preamble on the determined RO 302 to initiate communication with an NE. The NE may monitor the ROs 302 to detect RACH preambles transmitted by UEs and may use the SSB-to-RO mapping to determine the beam direction from which a UE transmitted the RACH preamble based on the RO 302 on which the preamble was received.

In some examples, the resource diagram 300 includes one or more unused ROs 304, which represent ROs that are not mapped to any SSB indices. The resource diagram 300 includes one or more PRACH slots, such as the PRACH slot 306, PRACH slot 308, PRACH slot 310, and PRACH slot 312. A PRACH slot may be an example of time-domain resources (e.g., in units of slots) allocated for PRACH transmissions. The PRACH slot 306 and PRACH slot 308 may be within a PRACH configuration period 314, and the PRACH slot 310 and PRACH slot 312 may be within a PRACH configuration period 316. The PRACH configuration period 314 and PRACH configuration period 316 together form an association period 318. The association period 318 is a time period over which SSB indices are associated with ROs across multiple PRACH configuration periods. For example, a number of SSBs indicated to the UE 104 as being transmitted may equal ten (e.g., NSSB Tx=10). The transmitted SSBs may have indices {0, 1, 8, 9, 16, 17, 24, 25, 32, 33}. An NE may map each SSB to two ROs (e.g., N=½). A number of frequency division multiplexed ROs may equal two. A number of time-domain ROs in one PRACH slot may equal three. A number of PRACH slots in one PRACH configuration period may equal two. The resource diagram 300 displays numerical values representing SSB indices mapped to respective ROs 302, with values including 0, 1, 8, 9, 16, 17, 24, 25, 32, and 33 distributed across the ROs 302.

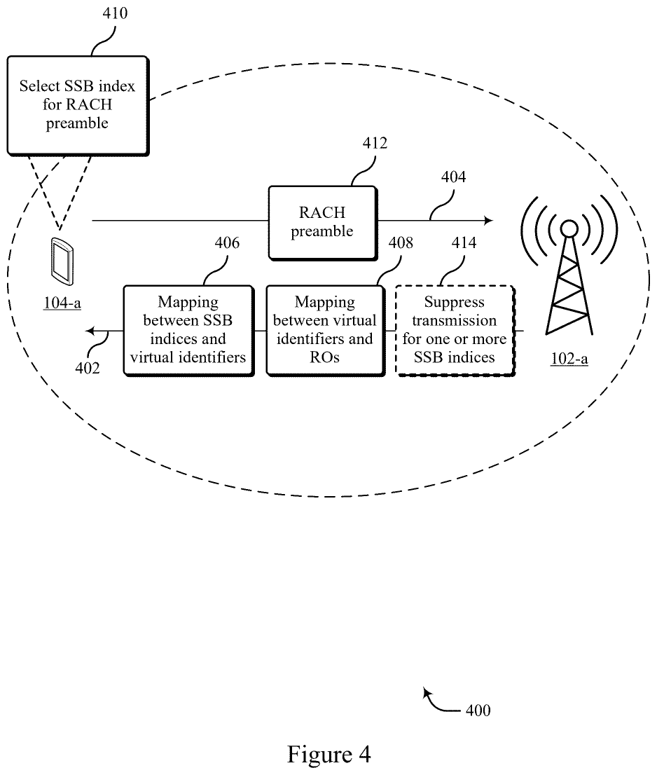

FIG. 4 illustrates an example of a wireless communications system 400 in accordance with aspects of the present disclosure. In some examples, the wireless communications system 400 implements aspects of the wireless communications system 100, the resource diagram 200, and/or the resource diagram 300. For example, the wireless communications system 400 includes an NE 102-a and a UE 104-a, which may be examples of an NE 102 and a UE 104 as described with reference to FIG. 1. In some examples, the UE 104-a and the NE 102-a may exchange signaling with one another. For example, the NE 102-a may transmit signaling to the UE 104-a via a downlink communications link 402, which may be an example of a communications link as described with reference to FIG. 1. In some other examples, the UE 104-a may transmit signaling to the NE 102-a via an uplink communications link 404, which may be an example of a communications link as described with reference to FIG. 1. The signaling between the UE 104-a and the NE 102-a may include control signaling and/or data transmissions.

In some examples, the NE 102-a transmits first signaling to the UE 104-a that indicates the mapping between SSB indices and virtual identifiers 406. The mapping between SSB indices and virtual identifiers 406 provides a level of abstraction between the SSB indices and ROs by associating each SSB index with one or more virtual identifiers. The mapping between SSB indices and virtual identifiers 406 may be indicated via a bitmap, where each bit position corresponds to an SSB index and the bit value indicates an associated virtual identifier. Additionally, or alternatively, the mapping between SSB indices and virtual identifiers 406 may be indicated via a list of SSB index-to-virtual identifier pairs, a table structure mapping SSB indices to corresponding virtual identifiers, and/or an index-based mapping, where SSB indices are implicitly mapped to virtual identifiers according to a defined ordering or offset. The virtual identifier may be an example of a virtual RO (VRO) identifier or a virtual RO group (VRO-G) identifier. A VRO identifier refers to a logical identifier that the NE 102-a associates with one or more SSB indices, where the VRO identifier is mapped to a single RO. The VRO identifier enables the NE 102-a to manage the association between SSB indices and ROs without directly coupling the SSB indices to time-frequency resources. For example, the mapping between SSB indices and virtual identifiers 406 may indicate that SSB index 0 corresponds to VRO 0, SSB index 1 corresponds to VRO 1, and SSB index 2 corresponds to VRO 2, where each VRO identifier serves as an intermediate reference that decouples the SSB index from physical RO resources. In some cases, multiple SSB indices may be mapped to the same VRO identifier, enabling multiple SSBs to share a common RO.

A VRO-G identifier refers to a logical identifier that the NE 102-a associates with one or more SSB indices, where the VRO-G identifier is mapped to a group of two or more ROs. In contrast to the VRO identifier that maps to a single RO, the VRO-G identifier enables the UE 104-a to support uplink beam sweeping. For uplink beam sweeping, the UE 104-a transmits repetitions of the RACH preamble on multiple ROs using different uplink transmit beams. For example, the mapping between SSB indices and virtual identifiers 406 may indicate that SSB index 0 corresponds to VRO-G 0, where VRO-G 0 is subsequently mapped to multiple ROs (e.g., RO 0, RO 1, and RO 2) via a mapping between virtual identifiers and ROs 408. Multiple SSB indices may be mapped to the same VRO-G identifier, enabling multiple SSBs to share a common group of ROs. The SSBs being mapped to VRO-G identifiers may enable the UE 104-a to transmit the RACH preamble on each RO within the group using different transmit beam directions to increase a probability that the NE 102-a receives the RACH preamble on at least one of the uplink beams.

The NE 102-a transmits second signaling to the UE 104-a that indicates the mapping between virtual identifiers and ROs 408. The mapping between virtual identifiers and ROs 408 associates the virtual identifiers with ROs, providing a level of abstraction that enables dynamic reallocation of ROs without modifying the mapping between SSB indices and virtual identifiers 406. The mapping between virtual identifiers and ROs 408 may be indicated via a bitmap, where each bit position corresponds to an RO and the bit value indicates activation or deactivation of the RO for a given virtual identifier. Additionally, or alternatively, the mapping between virtual identifiers and ROs 408 may be indicated via a list of virtual identifier-to-RO pairs indicating which ROs are associated with each virtual identifier, a sequence of RO indices associated with each virtual identifier, and/or a table structure mapping virtual identifiers to corresponding sets of ROs. The NE 102-a maps each SSB index to a VRO or VRO-G, and dynamically binds each VRO or VRO-G to one or more ROs via the mapping between virtual identifiers and ROs 408. The NE 102-a dynamically binds the VRO and/or VRO-G to the ROs by associating or linking a virtual identifier (e.g., a VRO identifier or VRO-G identifier) with one or more ROs for RACH preamble transmission and reception. For example, if the virtual identifier includes a VRO identifier, then the NE 102-a may bind the VRO identifier to a single RO or to multiple ROs that share the same VRO identifier. If the virtual identifier includes the VRO-G identifier, then the NE 102-a may bind the VRO-G identifier to two or more ROs, which may be used for transmitting repetitions of the RACH preamble on the two or more ROs.

Thus, the virtualization operates at a beam level per SSB, rather than at the physical time and/or frequency resource level. For example, the mapping follows a hierarchical structure with two distinct mappings, including the mapping between SSB indices and virtual identifiers 406 and the mapping between virtual identifiers and ROs 408. In the mapping between SSB indices and virtual identifiers 406, the SSB index maps to a virtual identifier (e.g., a VRO identifier and/or a VRO-G identifier), which is a logical construct internal to the NE 102-a. In the mapping between virtual identifiers and ROs 408, the virtual identifier maps to an RO (e.g., which includes time, frequency, and FDM resources). Based on the two mappings, the UE 104-a perceives a fixed SSB-to-RO mapping, while the NE 102-a dynamically manages resource usage per beam.

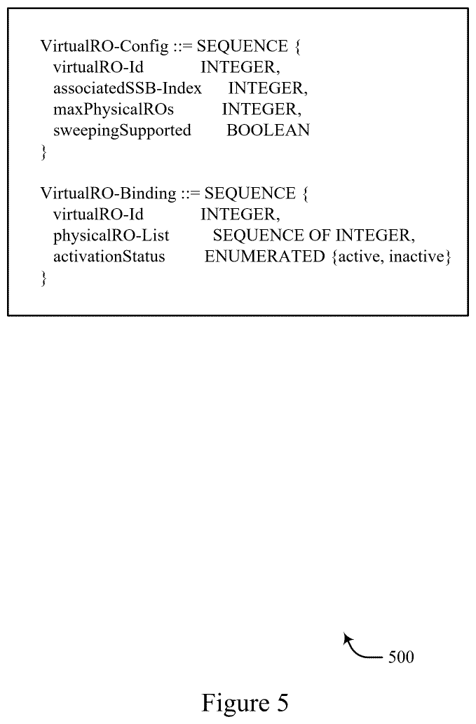

The NE 102-a may signal the mapping between SSB indices and virtual identifiers 406 and the mapping between virtual identifiers and ROs 408 to the UE 104-a using various signaling mechanisms for initial configuration and subsequent updates. For initial configuration, the NE 102-a may transmit the mapping between SSB indices and virtual identifiers 406 via RRC configuration (e.g., using a SIB1), which enables broadcast configuration to multiple UEs within the coverage area of the NE 102-a. The NE 102-a may include the mapping between SSB indices and virtual identifiers 406 in a RACH-ConfigCommon information element (IE) or a dedicated VirtualRO-Config 1E within SIB1, which is described in further detail with respect to FIG. 5. The NE 102-a may transmit the mapping between virtual identifiers and ROs 408 via the SIB1 for broadcast configuration, or via dedicated RRC reconfiguration signaling for UE-specific configuration (e.g., via the same signaling or different signaling as the mapping between SSB indices and virtual identifiers 406). The dedicated RRC reconfiguration signaling may include a VirtualRO-Binding ID that indicates the association between each virtual identifier and one or more physical ROs, as well as an activation status indicating whether the binding is active or inactive, which is described in further detail with respect to FIG. 5.

For subsequent updates to the mappings, the NE 102-a may utilize lower-layer signaling mechanisms that provide reduced latency compared to RRC reconfiguration. For example, the NE 102-a may transmit a beam-RACH MAC-CE to dynamically update the mapping between virtual identifiers and ROs 408. The MAC-CE may include a bitmap indicating which virtual identifier-to-RO bindings are activated or deactivated, enabling the NE 102-a to reallocate ROs to different virtual identifiers without modifying the mapping between SSB indices and virtual identifiers 406. Additionally, or alternatively, the NE 102-a may utilize layer 1 (L1) signaling for rapid reconfiguration of the mapping between virtual identifiers and ROs 408. The L1 signaling may include DCI transmitted on a physical downlink control channel (PDCCH) or a downlink WUS. The DCI or WUS may include a field indicating an update to the virtual identifier-to-RO binding, such as activating or deactivating bindings or reassigning ROs to different virtual identifiers. The use of L1 signaling enables the NE 102-a to rapidly reconfigure the mapping between virtual identifiers and ROs 408 in response to changing traffic conditions or beam suppression decisions, while maintaining the stability of the mapping between SSB indices and virtual identifiers 406.

At 410, the UE 104-a selects an SSB index for a RACH preamble 412. For example, the UE 104-a selects an SSB index for a downlink beam that maximizes a quality metric or performance indicator. For example, the UE 104-a may perform respective measurements on signaling received from respective beams of a set of available beams. Each beam has an associated SSB index. The UE 104-a may determine the available beams by monitoring for SSB transmissions within an SSB burst and identifying SSBs that satisfy a detection threshold (e.g., an RSRP threshold or an SINR threshold). The measurements may be performed on reference signals included in the SSBs, such as the PSS, the SSS, and/or the PBCH demodulation reference signal (DMRS). The measurements may include, but are not limited to, RSRP, RSRQ, SINR, or other quality metrics. The UE 104-a may compare the measurements for respective beams to determine a beam and corresponding SSB index that has a highest quality of the set of beams, such as a highest RSRP value or a highest SINR value.

The UE 104-a uses the mapping between SSB indices and virtual identifiers 406 to determine the virtual identifier mapped to the selected SSB index. For example, if the UE 104-a selects SSB index 0, then the UE 104-a identifies the virtual identifier (e.g., VRO 0 or VRO-G 0) that is mapped to SSB index 0 using the mapping between SSB indices and virtual identifiers 406. The UE 104-a then uses the mapping between virtual identifiers and ROs 408 to determine the RO or set of ROs corresponding to the identified virtual identifier. For example, if the virtual identifier is VRO 0, then the UE 104-a determines the single RO mapped to VRO 0 based on the second mapping. If the virtual identifier is VRO-G 0, then the UE 104-a determines the group of ROs (e.g., RO 0, RO 1, and RO 2) mapped to VRO-G 0 based on the second mapping.

The UE 104-a transmits a RACH preamble 412 during the determined RO (e.g., linked to the virtual identifier) to initiate communication with the NE 102-a. If the virtual identifier is mapped to multiple ROs (e.g., for a VRO-G identifier), and if the UE 104-a is capable of performing uplink beam sweeping, then the UE 104-a transmits one or more repetitions of the RACH preamble 412 across the multiple ROs. The UE 104-a transmits the RACH preamble 412 by indicating explicitly or implicitly the virtual identifier that reflects the selected SSB index. For example, the UE 104-a may explicitly indicate the virtual identifier by transmitting the RACH preamble 412 using a preamble index or other field in the RACH preamble 412 that is partitioned or reserved for the virtual identifier, where different preamble indices within an RO correspond to different virtual identifiers or the field indicates the virtual identifier directly. The NE 102-a may configure the preamble partitioning, such that a first subset of preamble indices (e.g., preamble indices 0 through 15) corresponds to a first virtual identifier, a second subset of preamble indices (e.g., preamble indices 16 through 31) corresponds to a second virtual identifier, and so on. The UE 104-a selects a preamble index from the subset corresponding to the virtual identifier mapped to the selected SSB index, thereby explicitly indicating the virtual identifier to the NE 102-a. Additionally, or alternatively, the UE 104-a may implicitly indicate the virtual identifier by transmitting the RACH preamble 412 on an RO that is uniquely mapped to the virtual identifier via the mapping between virtual identifiers and ROs 408. In the implicit indication, the NE 102-a determines the virtual identifier using the RO on which the RACH preamble 412 is received, rather than using the preamble index or other field in the RACH preamble 412. For example, if RO 0 is mapped exclusively to VRO 0, then the NE 102-a implicitly determines that the UE 104-a selected an SSB index corresponding to VRO 0 by receiving the RACH preamble 412 on RO 0.

The NE 102-a receives the RACH preamble 412 and determines the virtual identifier mapped to the RO using the mapping between virtual identifiers and ROs 408. The NE 102-a determines the SSB index mapped to the virtual identifier using the mapping between SSB indices and virtual identifiers 406. The NE 102-a then infers the selected downlink beam from the SSB index. The NE 102-a may map non-overlapping or overlapping ROs to multiple virtual identifiers. For example, in a non-overlapping configuration, each RO may be associated with a single virtual identifier, such that different virtual identifiers correspond to distinct sets of ROs without any shared ROs between the virtual identifiers. In an overlapping configuration, a single RO may be associated with multiple virtual identifiers, such that two or more virtual identifiers share one or more common ROs.

The NE 102-a may transmit signaling to suppress transmission for one or more SSB indices 414 (e.g., mute one or more beams) to the UE 104-a. The signaling to suppress transmission for one or more SSB indices 414 indicates that transmissions linked to one or more SSB indices are suppressed, which triggers deactivation of the mapping between virtual identifiers and ROs 408 for the corresponding virtual identifiers. For UEs in an idle or inactive state, the NE 102-a may transmit the signaling to suppress transmission for one or more SSB indices 414 via system information (e.g., SIB1 modification), where a beamGroupActivation bitmap indicates which beam groups are active or suppressed. Each bit position in the bitmap corresponds to a beam group index, and a bit value of 0 indicates that the corresponding beam group is suppressed, while a bit value of 1 indicates that the beam group is active. For UEs in a connected state, the NE 102-a may transmit the signaling to suppress transmission for one or more SSB indices 414 via a MAC-CE or DCI for reduced latency. The MAC-CE may include a beam-RACH-Suppression field including a bitmap, where each bit corresponds to an SSB index or beam group, and the bit value indicates whether transmissions for the corresponding SSB index or beam group are suppressed. The DCI may include a beamSuppressionIndicator field that references a configured suppression pattern or directly indicates the SSB indices or beam groups to be suppressed. Additionally, or alternatively, the NE 102-a may transmit the signaling to suppress transmission for one or more SSB indices 414 via a WUS that includes a suppressedBeamList field indicating the SSB indices or beam groups for which transmissions are suppressed. The signaling to suppress transmission for one or more SSB indices 414 may also include a suppressionDuration field indicating a time period during which the suppression is active, and a compactionMode field indicating whether the NE 102-a applies time shifting, frequency repacking, or disabled mode for the remaining beam groups.

If the NE 102-a mutes a beam, then the NE 102-a temporarily unbinds the virtual identifier linked to that beam from ROs without impacting other beams. Unbinding a virtual identifier linked to a beam from ROs refers to disassociating or removing the link between a virtual identifier (e.g., a VRO identifier or VRO-G identifier) and one or more ROs, such that the virtual identifier no longer maps to the ROs for purposes of RACH preamble transmission and reception. Table 3 illustrates an example mapping between SSB indices, VRO identifiers, and ROs, including the activation status of each mapping. For example, SSB index 0 is mapped to VRO-0, which is bound to RO-0 at time to and frequency f0, and the mapping is active. SSB index 1 is mapped to VRO-1, which is bound to RO-1 at time to and frequency f1, and the mapping is active. SSB index 2 is mapped to VRO-2, which has no associated RO because the mapping is muted. SSB index 3 is mapped to VRO-3, which is bound to RO-0 at time t1 and frequency f0, and the mapping is active. If the NE 102-a mutes the SSB-2 beam, then the NE 102-a unbinds VRO-2 from physical resources (e.g., ROs). The NE 102-a may reuse RO-0 by multiple beams at different times.

TABLE 3
Example mapping between SSB indices, VRO identifiers, and ROs

| SSB index | VRO identifier | RO | Status |
|---|---|---|---|
| 0 | VRO-0 | RO-0 (t0, f0) | Active |
| 1 | VRO-1 | RO-1 (t0, f1) | Active |
| 2 | VRO-2 | N/A | Muted |
| 3 | VRO-3 | RO-0 (t1, f0) | Active |

Table 4 illustrates an example mapping between SSB indices, VRO-G identifiers, and RO sets for uplink beam sweeping. For example, SSB index 0 is mapped to VRO-G0, which is bound to a set of three ROs, including RO-0, RO-1, and RO-2. SSB index 1 is mapped to VRO-G1, which is bound to a different set of three ROs, including RO-3, RO-4, and RO-5. The VRO-G identifier enables the UE 104-a to transmit repetitions of the RACH preamble 412 across multiple ROs using different uplink transmit beams, thereby increasing the probability that the NE 102-a successfully receives the RACH preamble 412 on at least one of the uplink beams.

TABLE 4
Example mapping between SSB indices,
VRO-G identifiers, and RO sets

| SSB index | VRO-G identifier | RO set |
|---|---|---|
| 0 | VRO-G0 | {RO-0, RO-1, RO-2} |
| 1 | VRO-G1 | {RO-3, RO-4, RO-5} |

Table 5 illustrates an example mapping between uplink transmit beams and ROs for uplink beam sweeping within a VRO-G. For example, the UE 104-a transmits the RACH preamble 412 on RO-3 using uplink transmit Beam A, on RO-4 using uplink transmit Beam B, and on RO-5 using uplink transmit Beam C. The mapping between uplink transmit beams and ROs enables the UE 104-a to sweep across different uplink beam directions when transmitting repetitions of the RACH preamble 412, thereby increasing the likelihood that the NE 102-a successfully receives the RACH preamble 412 on at least one of the uplink beams. The NE 102-a may configure the mapping between uplink transmit beams and ROs via higher-layer signaling, such as RRC signaling, to indicate which ROs within a VRO-G correspond to which uplink transmit beam directions.

TABLE 5
Example mapping between uplink transmit beams and ROs

| Uplink transmit beam | RO |
|---|---|
| Beam A | RO-3 |
| Beam B | RO-4 |
| Beam C | RO-5 |

The NE 102-a may group SSB indices into beam groups to facilitate coordinated management of beams that cover similar spatial regions. A beam group refers to a logical grouping of one or more SSB indices (e.g., and corresponding beams) that are directed towards a common spatial direction or coverage area. The NE 102-a may configure beam groups using higher-layer signaling, where each beam group is defined by a set of SSB indices that share a common spatial region. The configuration includes the SSB-to-beam group mapping, per-beam group RO allocation parameters, preamble partitioning within each beam group, and/or transmit beam sweeping support per beam group.

The NE 102-a may implement adaptation mechanisms to control spatial muting and compaction of beam groups. For example, a Level 1 adaptation mechanism controls the spatial muting and compaction of beam groups. If the NE 102-a determines that a beam group has no UEs, then the NE 102-a marks the beam group as mutable and updates a bitmap (e.g., a beamGroupActivation bitmap). The NE 102-a may determine that a beam group has no UEs by evaluating RACH load measurements, RRC connection counts, and/or UE measurement reports. For example, the NE 102-a may determine to mute a beam group by tracking a traffic load for RACH-related signaling (e.g., a RACH load) per beam group according to Equation 1:

$$L ( {BG}_{i} ) = \frac{number of detected RACH preambles in {BG}_{i}}{number of available ROs in {BG}_{i}} \qquad ( 1 )$$

The NE 102-a may track the traffic load over a configurable measurement window.

If the traffic load per beam group, L(BGᵢ), falls below a threshold for a numerical quantity of consecutive cluster periods, N, then the NE 102-a flags the beam group for muting. The NE 102-a triggers reactivation of the beam group if the NE 102-a detects a preamble on an RO of a neighboring beam group from a UE with a Msg3 beam report that indicates a spatial direction covered by the muted beam group. Additionally, or alternatively, the NE 102-a triggers reactivation of the beam group periodically through probe transmissions. For example, the NE may periodically transmit signaling on an additional beam group that covers a spatial direction similar to or overlapping with a suppressed beam group. The signaling may include SSBs, system information, or other reference signals that enable UEs located in the spatial direction to detect the presence of the NE and initiate a random access procedure. In response to detecting the signaling, a UE located in the spatial direction may transmit a RACH preamble to the NE 102-a. Upon receiving the RACH preamble, the NE 102-a may cancel suppression of the transmission for the beam group, thereby reactivating the mapping between the virtual identifiers and the ROs for the beam group. The periodicity of the probe transmissions may be configured based on expected UE mobility patterns, traffic load variations, or network deployment characteristics, among other example factors.

In some cases, the NE 102-a conveys the beam group activation state through a bitmap, such as a beamGroupActivation bitmap. The NE 102-a can dynamically update the beamGroupActivation bitmap via SIB 1 modification for idle and/or inactive UEs, or via group-common DCI or MAC-CE for connected UEs. Within each active beam group, the common channels may optionally be organized as sub-bursts, which enables independent scaling of each channel type. For example, the common channels of the beam group may be organized as an SSB sub-burst, a RACH sub-burst, a SIB1 sub-burst, and a paging sub-burst.

If the NE 102-a suppresses transmissions for SSB indices, then the NE 102-a may dynamically reallocate the corresponding ROs to other SSBs or beam groups without updating the mapping between SSB indices and virtual identifiers 406. If the NE 102-a mutes an SSB beam or corresponding ROs, then the NE 102-a shifts one or more remaining common channel resources of other beams forward in the time domain to eliminate time gaps and reduce total cluster duration. The NE 102-a may perform a compaction procedure to rearrange beam group clusters according to a configured compaction mode, according to Table 6.

TABLE 6
Compaction procedures to rearrange beam group clusters

| Mode | Behavior | Benefit |
|---|---|---|
| timeShift | Remaining beam group clusters slide | Maximizes contiguous sleep duration |
| | earlier in time. Slots of muted beam | for both NEs and UEs. Enables deep |
| | groups are eliminated entirely. The | sleep states (e.g., micro-sleep, radio |
| | trailing portion of the cluster period | frequency shutdown). |
| | becomes a contiguous DTX window. | |
| freqRepack | ROs from remaining beam groups are | Reduces time-domain resource usage. |
| | repacked onto fewer FDM occasions, | May allow shorter active windows |
| | reducing the time-domain footprint, | when frequency resources are |
| | while maintaining the same total RO | available. |
| | capacity. | |
| disabled | RO and/or SSB positions remain at | Simplest UE implementation. No re- |
| | originally configured time slots. Slots | computation of timing performed. |
| | of muted beam groups are left empty | NEs can micro-sleep during empty |
| | (e.g., not transmitted or monitored). | slots. |

The compaction mode may include time shifting, frequency repacking, or both. For time shifting, remaining beam group clusters move earlier in time and the slot of a muted beam group is eliminated entirely, such that the trailing portion of the cluster period becomes a contiguous DTX window. For frequency repacking, ROs from remaining beam groups are repacked onto fewer FDM occasions to reduce the time-domain footprint, while maintaining the same total RO capacity. Additionally, or alternatively, the NE 102-a may implement a disabled mode, where RO and/or SSB positions remain at originally configured time slots and slots of muted beam groups are left empty, rather than being compacted to achieve contiguous transmission.

In some examples, the wireless communications system 400 may implement different techniques for organizing common channel resources. For example, the wireless communications system 400 may implement per-beam clustering, where the NE 102-a groups common channels for a single beam together as an atomic unit, as described in further detail with respect to FIG. 6. The wireless communications system 400 may implement per-burst clustering, where beams of the same channel type form a burst, which is described in further detail with respect to FIG. 7. Per-beam clustering excels in spatial beam muting with simple compaction and superior energy savings, while per-burst clustering enables channel-type-specific scaling, but fragments sleep opportunities. A third clustering opportunity uses a hybrid hierarchical clustering architecture that captures the advantages of both approaches through a two-level design, which is described in further detail with respect to FIG. 8.

For SSB-to-RO mappings that do not implement the level of abstraction that the virtual identifiers provide, muting one spatial direction collapses the mapping for all beams. The virtual identifiers result in the UE-visible mapping being static, while enabling the NE 102-a to dynamically manage resource usage per beam (e.g., SSB). An RO may also be referred to as, include, or be an example of a physical RO, a PRACH occasion, or RACH resources.

FIG. 5 illustrates an example of a mapping configuration 500 in accordance with aspects of the present disclosure. In some examples, the mapping configuration 500 implements or is implemented by aspects of the wireless communications system 100, the resource diagram 200, the resource diagram 300, and/or the wireless communications system 400. For example, the mapping configuration 500 may be implemented by one or more UEs and/or NEs, which may be an example of NEs 102 and UEs 104 as described with reference to FIG. 1. The mapping configuration 500 illustrates an example signaling structure for virtual RO configuration and binding.

An NE and a UE may exchange signaling using various signaling to configure and update the mappings between SSB indices, virtual identifiers, and ROs. The signaling may include, but is not limited to, SIB1 for broadcast configuration, which enables the NE 102-a to transmit the mapping between SSB indices and virtual identifiers and the mapping between virtual identifiers and ROs to multiple UEs within the coverage area. Additionally, or alternatively, the signaling may include a dedicated RRC reconfiguration for UE-specific configuration, which enables the NE to transmit UE-specific virtual RO configurations to individual UEs. Additionally, or alternatively, the signaling may include a beam-RACH MAC-CE for dynamic updates, which enables the NE to dynamically update the mapping between virtual identifiers and ROs with reduced latency compared to RRC reconfiguration. Additionally, or alternatively, the signaling may include L1 updates using DCI or a downlink WUS for rapid reconfiguration, which enables the NE to dynamically reconfigure the virtual identifier-to-RO bindings in response to changing traffic conditions or beam suppression decisions.

The mapping configuration 500 includes a VirtualRO-Config data structure defined as a sequence including a virtualRO-Id field of type INTEGER, an associatedSSB-Index field of type INTEGER, a maxPhysicalROs field of type INTEGER, and a sweepingSupported field of type BOOLEAN. The mapping configuration 500 also includes a VirtualRO-Binding data structure defined as a sequence including a virtualRO-Id field of type INTEGER, a physicalRO-List field of type SEQUENCE OF INTEGER, and an activationStatus field of type ENUMERATED with values active and inactive. The VirtualRO-Config data structure defines the relationship between virtual RO identifiers and SSB indices, while the VirtualRO-Binding data structure defines the association between virtual RO identifiers and physical ROs, as well as the activation state of the bindings.

FIG. 6 illustrates an example of a transmission diagram 600 in accordance with aspects of the present disclosure. In some examples, the transmission diagram 600 implements or is implemented by aspects of the wireless communications system 100, the resource diagram 200, the resource diagram 300, the wireless communications system 400, and/or the mapping configuration 500. For example, the transmission diagram 600 may be implemented by one or more UEs and/or NEs, which may be an example of NEs 102 and UEs 104 as described with reference to FIG. 1. The transmission diagram 600 illustrates an example of per-beam clustering of common channel resources.

For per-beam clustering, an NE transmits an SSB burst 602 including more than one SSB per beam, followed by a SIB1 604, an RO 606, and a PO 608. The SSB burst 602 may include repetitions of SS/PBCH signals transmitted consecutively. Additionally, or alternatively, the SSB burst 602 may include one SS/PBCH signal followed by an SS signal without PBCH. As shown in the transmission diagram 600, an SSB burst 602 is followed by SIB1 604, RO 606, and PO 608 for a first beam (e.g., beam 1), and then another SSB burst 602 is followed by SIB1 604, RO 606, and PO 608 for a second beam (e.g., beam 2). The SSB burst 602 includes synchronization signals and broadcast channel information that enable UEs to synchronize with the NE and obtain initial system information. The SIB1 604 provides system information for initial access, including configuration parameters for random access procedures. The RO 606 represents a time-frequency resource during which UEs may transmit RACH preambles to initiate random access procedures. The PO 608 represents a paging occasion during which the NE transmits paging messages to notify UEs of incoming signaling. The transmission diagram 600 includes an active duration 610 during which the common channels for both beams are transmitted. During the active duration 610, the NE transmits the SSB bursts 602, SIB1 604, ROs 606, and POs 608 for each beam in sequence. Following the active duration 610, the transmission diagram 600 includes an inactive duration 612 during which the NE may enter a low-power state. The inactive duration 612 enables the NE 102-a to reduce power consumption by deactivating transmitter components when transmission is not occurring. Per-beam clustering groups all common channels for a single beam together as an atomic unit, which simplifies compaction when the NE mutes one or more beams, because the NE can eliminate the entire beam cluster without affecting other beams.

FIG. 7 illustrates an example of a transmission diagram 700 in accordance with aspects of the present disclosure. In some examples, the transmission diagram 700 implements or is implemented by aspects of the wireless communications system 100, the resource diagram 200, the resource diagram 300, the wireless communications system 400, and/or the mapping configuration 500. For example, the transmission diagram 700 may be implemented by one or more UEs and/or NEs, which may be an example of NEs 102 and UEs 104 as described with reference to FIG. 1. The transmission diagram 700 illustrates an example of per-burst clustering of common channel resources.

For per-burst clustering, an NE clusters each signal or channel for all beams first, then clusters the second signal or channel for all beams, and continues the pattern for remaining signals and channels. As shown in the transmission diagram 700, an SSB burst 702 including SSBs for multiple beams is transmitted on a first beam (e.g., beam 1), followed by a SIB burst 704 including SIBs for multiple beams on a second beam (e.g., beam 2), and then a RACH burst 706 including RACHs (e.g., ROs) for multiple beams on one or more additional beams (e.g., a beam at 708 and/or a beam at 710). The SSB burst 702 includes synchronization signals and broadcast channel information for beams transmitted consecutively, enabling UEs to synchronize with the NE and obtain initial system information across multiple spatial directions. The SIB burst 704 provides system information for initial access across beams, including configuration parameters for random access procedures. The RACH burst 706 represents time-frequency resources during which UEs may transmit RACH preambles to initiate random access procedures for any of the supported beams.

The transmission diagram 700 includes an active duration 712 during which all bursts are transmitted. During the active duration 712, the NE transmits the SSB burst 702, SIB burst 704, and RACH burst 706 in sequence for all beams. Following the active duration 712, the transmission diagram 700 includes an inactive duration 714 during which the NE may enter a low-power state. The inactive duration 714 enables the NE to reduce power consumption by deactivating transmitter components when transmission is not occurring. Per-burst clustering groups instances of a signal or channel type together across beams, which may provide flexibility in resource allocation and enable efficient scheduling of common channel transmissions.

FIG. 8 illustrates an example of a transmission diagram 800 in accordance with aspects of the present disclosure. In some examples, the transmission diagram 800 implements or is implemented by aspects of the wireless communications system 100, the resource diagram 200, the resource diagram 300, the wireless communications system 400, the mapping configuration 500, the transmission diagram 600, and/or the transmission diagram 700. For example, the transmission diagram 800 may be implemented by one or more UEs and/or NEs, which may be an example of NEs 102 and UEs 104 as described with reference to FIG. 1. The transmission diagram 800 illustrates an example of hierarchical two-level clustering with beam groups.

In some examples, the transmission diagram 800 illustrates an example of a hybrid architecture that combines per-beam clustering, as described with reference to FIG. 6, and per-burst clustering, as described with reference to FIG. 7. For example, the hybrid architecture combines spatial adaptation flexibility (e.g., per-beam) with channel-type adaptation granularity (e.g., per-burst). The hybrid architecture includes a two-level organizational structure for common channel resources within each cluster period. In some examples, a first level of the hybrid architecture (e.g., level 1, outer layer) includes per-beam grouping, where the NE organizes SSB beams into beam groups. Each beam group represents a spatial cluster of beams covering a defined angular region and functions as an atomic scheduling unit for spatial adaptation. The NE can mute or activate the entire beam group and corresponding common channels without affecting other beam groups. If the NE mutes a beam group, then the NE time-shifts (e.g., compacts) one or more clustered channels and/or signals for remaining beam groups to create a contiguous active transmission window followed by an extended DTX period.

A second level of the hybrid architecture (e.g., level 2, inner layer) includes per-burst within beam group, where within each active beam group, the NE may optionally organize the common channels (e.g., SSB, RACH, SIB1, paging) as sub-bursts. The organization enables channel-type-specific adaptation within a beam group. For example, the NE may reduce the number of ROs for beams within a beam group, while maintaining full SSB coverage for the same beams. The sub-burst organization is secondary to the beam group-level grouping, ensuring that spatial adaptation remains the primary and simplest adaptation mechanism.

As shown in the transmission diagram 800, a beam group 0 burst includes SSBs (e.g., S0, S1, and S2), SIBs (e.g., SIB0, SIB1, and SIB2), and ROs (e.g., RO0, RO1, and RO2) for a first set of beams, followed by a beam group 1 burst including SSBs (e.g., SO, S1, and S2), SIBs (e.g., SIB0, SIB1, and SIB2), and ROs (e.g., RO0, RO1, and RO2) for a second set of beams. The transmission diagram 800 includes an active duration 802 spanning both beam group bursts. During the active duration 802, the NE transmits the beam group bursts in sequence for each configured beam group. Following the active duration 802, the transmission diagram 800 includes an inactive duration 804 during which the NE may enter a low-power state. The inactive duration 804 enables the NE to reduce power consumption by deactivating transmitter components when transmission is not occurring.

The NE configures beam groups using higher-layer signaling. Each beam group is defined by a set of SSB indices that share a common spatial region. The network configures the beam group structure via higher-layer signaling (e.g., SIB1 or dedicated RRC signaling for RRC_CONNECTED UEs). The configuration includes the SSB-to-beam group mapping, per-beam group RO allocation parameters, preamble partitioning within each beam group, and/or transmit beam sweeping support per beam group. The NE conveys the beam group activation state through a beamGroupActivation bitmap, which the NE can dynamically update via SIB1 modification (e.g., for idle and/or inactive UEs) or via group-common DCI and/or MAC-CE (e.g., for connected UEs). Each bit in the bitmap indicates the state of one beam group, where a value of 1 indicates that the beam group is active (e.g., the NE transmits common channels linked to the beam group), and a value of 0 indicates that the beam group is muted (e.g., the NE suppresses common channels linked to the beam group).

Tables 7 and 8 illustrate example IEs for configuring common channel clustering and beam group parameters. Table 7 illustrates a common channel IE that includes fields for configuring the cluster periodicity, the number of beam groups, the beam group activation bitmap, the compaction mode, and a list of per-beam group configurations. Table 8 illustrates a per-beam group configuration that includes fields for specifying the SSB indices assigned to the beam group, RO allocation parameters, the SSB-to-RO mapping ratio within the beam group, preamble partitioning for beam indication, optional intra-group burst configuration for level 2 sub-burst organization, and transmit beam sweeping support parameters.

TABLE 7
Common channel IE

| IE/Field | Type | Description |
|---|---|---|
| clusterPeriodicity | ENUM | {milliseconds (ms)20, ms40, ms80, ms160}; |
| | | Periodicity of the common channel cluster |
| | | window |
| nrOfBeamGroups | INTEGER | Number of beam groups (1 . . . maxBeamGroups, |
| | | where maxBeamGroups ≤ 8) |
| beamGroupActivation | BIT STRING | Bitmap of size maxBeamGroups indicating |
| | | which beam groups are active; dynamically |
| | | updatable |
| compactionMode | ENUM | {disabled, timeShift, freqRepack}; How |
| | | remaining beam groups fill gaps after muting |
| beamGroupConfigList | SEQUENCE | Per-beam group configuration (e.g., see |
| | | BeamGroupConfig below) |

TABLE 8
Per-beam group configuration

| BeamGroupConfig Field | Type | Description |
|---|---|---|
| ssbIndicesInGroup | BIT | SSB indices assigned to this beam group |
| | STRING(64) | |
| roAllocationPerBG | SEQUENCE | RO allocation parameters specific to this beam |
| | | group (e.g., time and/or frequency resources, |
| | | msg1-FDM per beam group) |
| ssb-perRACH-PerBG | ENUM | SSB-to-RO mapping ratio within this beam |
| | | group (e.g., replaces global ssb-perRACH- |
| | | OccasionAndCB-PreamblesPerSSB) |
| preamblePartition | SEQUENCE | Preamble index ranges mapped to each SSB |
| | | within the beam group for beam indication |
| intraGroupBurstConfig | OPTIONAL | If present, enables Level 2 sub-burst organization |
| | | within the beam group; allows independent |
| | | RACH, SIB1, and/or paging scaling |
| txBeamSweepSupport | BOOLEAN | Indicates if uplink transmit beam sweeping RO |
| | | allocation is configured for this beam group |
| txBeamRO-Stride | INTEGER | RO index stride for transmit beam sweeping |
| | | within this beam group |

An NE may support hierarchical organization of common channels within beam groups. Within each active beam group, the common channels may optionally be organized as sub-bursts, enabling independent scaling of each channel type. The level 2 adaptation addresses scenarios where the NE maintains full SSB coverage for mobility measurements, while reducing RO density due to low initial access load for beams within the same beam group. If the NE configures intraGroupBurstConfig, then the common channels of the beam group are organized as SSB sub-burst (e.g., all SSBs in the beam group), RACH sub-burst (e.g., a configurable subset of ROs), SIB1 sub-burst, and paging sub-burst. The NE may independently scale the RACH sub-burst by adjusting the number of ROs or the ssb-perRACH-PerBG parameter without modifying the SSB sub-burst.

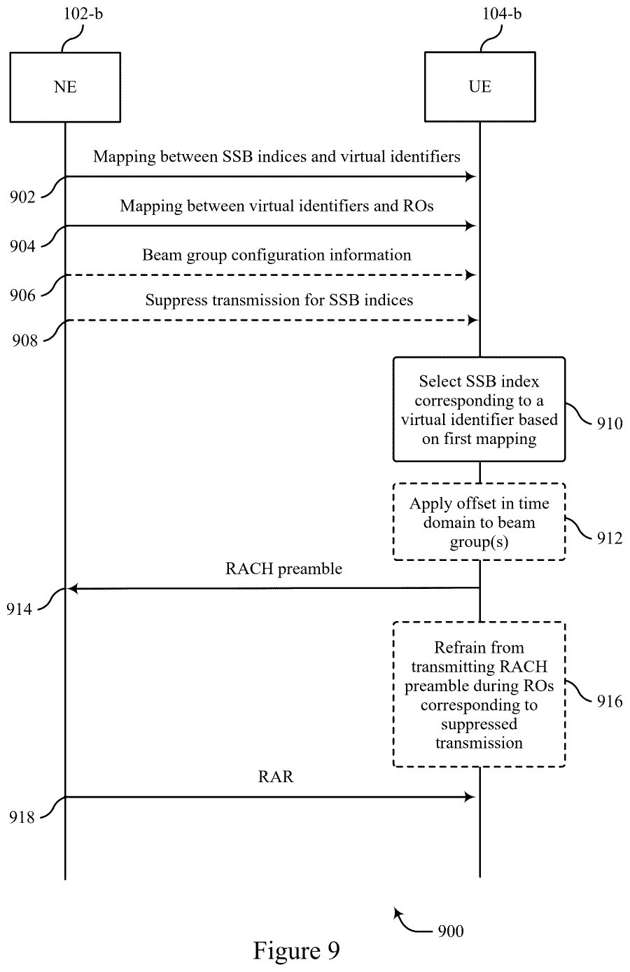

FIG. 9 illustrates an example of a signaling diagram 900 in accordance with aspects of the present disclosure. In some examples, the signaling diagram 900 implements or is implemented by aspects of the wireless communications system 100, the resource diagram 200, the resource diagram 300, the wireless communications system 400, the mapping configuration 500, the transmission diagram 600, the transmission diagram 700, and/or the transmission diagram 800. The signaling diagram 900 may implement or be implemented by NE 102-b and UE 104-b, which may be examples of the corresponding devices as described with reference to FIGS. 1 and 4. For example, the NE 102-b may provide the UE 104-b with a mapping between SSB indices and virtual identifiers, as well as a mapping between the virtual identifiers and ROs. Alternative examples of the following may be implemented, where some processes are performed in a different order than described or are not performed. In some cases, processes may include additional features not mentioned below, or further processes may be added.

At 902, the NE 102-b transmits first signaling that indicates a mapping between a set of SSB indices and a set of virtual identifiers (e.g., a first mapping) to the UE 104-b. For example, the NE 102-b transmits the first mapping via first RRC signaling, such as SIB1 or dedicated RRC reconfiguration signaling. The first mapping associates each SSB index (e.g., respective SSB indices of the set of SSB indices) with a corresponding virtual identifier, such as a VRO identifier or a VRO-G identifier. The virtual identifiers provide an abstraction layer that decouples the SSB indices from physical ROs, enabling dynamic reallocation of ROs without modifying the SSB-to-virtual-identifier mapping.

At 904, the NE 102-b transmits second signaling that indicates a mapping between the set of virtual identifiers and a set of ROs (e.g., a second mapping) to the UE 104-b. The second signaling may include at least one of the first RRC signaling (e.g., the same RRC signaling that indicates the first mapping), second RRC signaling (e.g., different RRC signaling than the RRC signaling that indicates the first mapping), a MAC-CE, a DCI, or a WUS. For example, the NE 102-b may transmit the second mapping via a MAC-CE to enable faster reconfiguration compared to RRC signaling, or via a WUS to update the mapping during a DRX cycle. The second mapping associates each virtual identifier (e.g., respective virtual identifiers) with one or more ROs. The virtual identifier may include at least one of a VRO identifier associated with one or more ROs of the set of ROs or a VRO-G identifier associated with two or more ROs of the set of ROs.

In some cases, at 906, the NE 102-b transmits fourth signaling that indicates beam group configuration information to the UE 104-b. The fourth signaling may indicate one or more of a mapping between the set of SSB indices and a set of beam groups (e.g., a third mapping), respective ROs associated with the set of beam groups, preamble partitioning within respective beam groups of the set of beam groups, or transmit beam sweeping support associated with the respective beam groups. For example, the fourth signaling may indicate that beam group 0 includes SSB indices 0, 1, and 2 covering a first spatial region (e.g., a northern sector of a cell), beam group 1 includes SSB indices 3, 4, and 5 covering a second spatial region (e.g., a southern sector of the cell), and that preambles 0 through 31 are allocated to beam group 0, while preambles 32 through 63 are allocated to beam group 1. A beam group of the set of beam groups includes one or more beams associated with one or more SSB indices. The one or more SSB indices may be associated with a common spatial region.

In some examples, at 908, the NE 102-b transmits third signaling that suppresses (e.g., mutes) a transmission associated with one or more SSB indices of the set of SSB indices to the UE 104-b. The NE 102-b may determine to suppress the transmission by determining respective RACH loads for the set of beam groups and over a measurement window. The respective RACH loads may include a numerical quantity of RACH preambles in a numerical quantity of available ROs. The transmission is suppressed for a beam group based on a RACH load for the beam group satisfying a threshold value. The third signaling may include a bitmap with at least one bit indicating to suppress the transmission associated with the beam group. For example, the bitmap may be a 4-bit field, where each bit corresponds to a beam group, and a value of 1011 indicates that beam group 2 is suppressed (e.g., inactive, muted), while beam groups 0, 1, and 3 remain active. The transmission may include a set of transmission types associated with the beam group, where the set of transmission types includes an SSB transmission type, a RACH transmission type, a system information transmission type, and a paging transmission type.

The NE 102-b may transmit fifth signaling that indicates respective numerical quantities of time-frequency resources associated with the set of transmission types. Respective transmission types of the set of transmission types are grouped in the time domain based on the respective numerical quantities of the time-frequency resources. The fifth signaling may include RRC signaling, a MAC-CE, DCI, or a combination thereof. For example, the fifth signaling may include an RRC IE that indicates a numerical quantity of slots or symbols allocated for SSB transmissions, a numerical quantity of slots or symbols allocated for system information transmissions, a numerical quantity of slots or symbols allocated for RACH transmissions, and a numerical quantity of slots or symbols allocated for paging transmissions. In some cases, the fifth signaling may include a MAC-CE that dynamically updates the numerical quantities of time-frequency resources for one or more of the transmission types. The NE 102-b may use the fifth signaling to configure the grouping of transmission types in the time domain, such that the NE 102-b transmits SSB bursts, followed by system information bursts, followed by RACH bursts, followed by paging bursts, based on the respective numerical quantities of time-frequency resources. The UE 104-b may receive the fifth signaling and determine, based on the respective numerical quantities of time-frequency resources, time-domain locations for monitoring or transmitting signaling associated with the respective transmission types. For example, the UE 104-b may determine a time-domain window for monitoring SSB transmissions, a time-domain window for monitoring system information transmissions, a time-domain window for transmitting RACH preambles, and a time-domain window for monitoring paging transmissions based on the fifth signaling.

At 910, the UE 104-b selects an SSB index of the set of SSB indices. The SSB index corresponds to a virtual identifier of the set of virtual identifiers based on the first mapping. To select the SSB index, the UE 104-b may perform respective measurements associated with a set of beams. The set of beams corresponds to the set of SSB indices. For example, the UE 104-b may measure RSRP values for SSBs corresponding to SSB indices 0, 1, 2, and 3, and determine that the SSB corresponding to SSB index 2 has an RSRP that is highest among the measured SSBs. The UE 104-b may determine that a beam corresponding to the SSB index has a highest quality of the set of beams using the respective measurements.

In some cases, at 912, the UE 104-b applies an offset in a time domain to beam groups of the set of beam groups. The UE 104-b applies the offset according to the third signaling and to beam groups other than the beam group associated with the suppressed transmission. For example, if beam group 1 is suppressed and beam groups 0, 1, and 2 were originally scheduled at time offsets of 0 ms, 5 ms, and 10 ms, respectively, then the UE 104-b may apply a −5 ms offset to beam group 2, resulting in beam group 2 being scheduled at 5 ms instead of 10 ms to maintain contiguous transmission. The beam groups are associated with contiguous transmission in the time domain based on the offset. The offset enables the UE 104-b to adjust timing for monitoring and transmission based on the compaction of beam group clusters resulting from the suppressed transmission.

At 914, the UE 104-b transmits a RACH preamble to the NE 102-b during an RO of the set of ROs. The RO corresponds to the virtual identifier based on the second mapping. For example, if the UE 104-b selected SSB index 2, which corresponds to VRO identifier 2 based on the first mapping, and VRO identifier 2 is mapped to RO 4 in PRACH slot 1 based on the second mapping, then the UE 104-b transmits the RACH preamble during RO 4 in PRACH slot 1. If the virtual identifier includes a VRO-G identifier, then the UE 104-b may transmit a set of repetitions of the RACH preamble on two or more ROs associated with the VRO-G identifier. For example, if VRO-G identifier 0 is associated with ROs 2, 3, and 4, the UE 104-b may transmit three repetitions of the RACH preamble, one on each of ROs 2, 3, and 4, to improve reception reliability at the NE 102-b.

In some examples, at 916, the UE 104-b refrains from transmitting the RACH preamble during one or more additional ROs based on the third signaling. The UE 104-b determines one or more first virtual identifiers corresponding to the one or more SSB indices based on the first mapping. The UE 104-b determines the one or more additional ROs of the set of ROs corresponding to the one or more first virtual identifiers based on the second mapping. For example, if the third signaling indicates suppression of SSB indices 3 and 4, the UE 104-b determines that VRO identifiers 3 and 4 correspond to SSB indices 3 and 4 based on the first mapping. The UE 104-b determines the one or more additional ROs of the set of ROs corresponding to the one or more first virtual identifiers based on the second mapping. For example, the UE 104-b determines that ROs 6 and 7 correspond to VRO identifiers 3 and 4 based on the second mapping, and therefore refrains from transmitting RACH preambles during ROs 6 and 7. The one or more additional ROs are associated with one or more second virtual identifiers based on the third signaling, which triggers deactivation of the second mapping between the one or more first virtual identifiers and the one or more additional ROs of the set of ROs.

At 918, the NE 102-b transmits a RAR to the UE 104-b in response to receiving the RACH preamble. The NE 102-b determines the virtual identifier corresponding to the RO based on the RO and the second mapping. The NE 102-b determines the SSB index corresponding to the virtual identifier based on the virtual identifier and the first mapping. The NE 102-b transmits the RAR on a beam corresponding to the SSB index. For example, if the NE 102-b receives the RACH preamble during RO 4 in PRACH slot 1, then the NE 102-b determines that RO 4 corresponds to VRO identifier 2 based on the second mapping. The NE 102-b determines that VRO identifier 2 corresponds to SSB index 2 based on the first mapping. The NE 102-b transmits the RAR on a beam corresponding to the SSB index. For example, the NE 102-b transmits the RAR using the beam associated with SSB index 2, which is the beam that the UE 104-b identified as having the highest quality.

In some cases, the NE 102-b may cancel suppression of the transmission for the beam group. For example, the NE 102-b may receive an additional RACH preamble on an additional beam group from a UE associated with a spatial direction covered by the beam group. The NE 102-b may cancel suppression of the transmission for the beam group based on the additional RACH preamble. For example, if beam group 1, covering a spatial direction, is suppressed, a UE located in the same or adjacent spatial direction may transmit a RACH preamble on beam group 0 because beam group 1 is unavailable. The NE 102-b may detect that the UE is located in the spatial direction covered by beam group 1 based on the preamble timing or signal characteristics, and cancel suppression of beam group 1 to serve the UE. Additionally, or alternatively, the NE 102-b may transmit fifth signaling based on a periodicity on an additional beam group associated with a spatial direction covered by the beam group. For example, the NE 102-b may transmit a discovery signal or an SSB on a beam covering the spatial direction of the suppressed beam group 1 to detect whether any UEs have entered the coverage area. The NE 102-b may receive an additional RACH preamble. The NE 102-b may cancel suppression of the transmission for the beam group based on the additional RACH preamble.

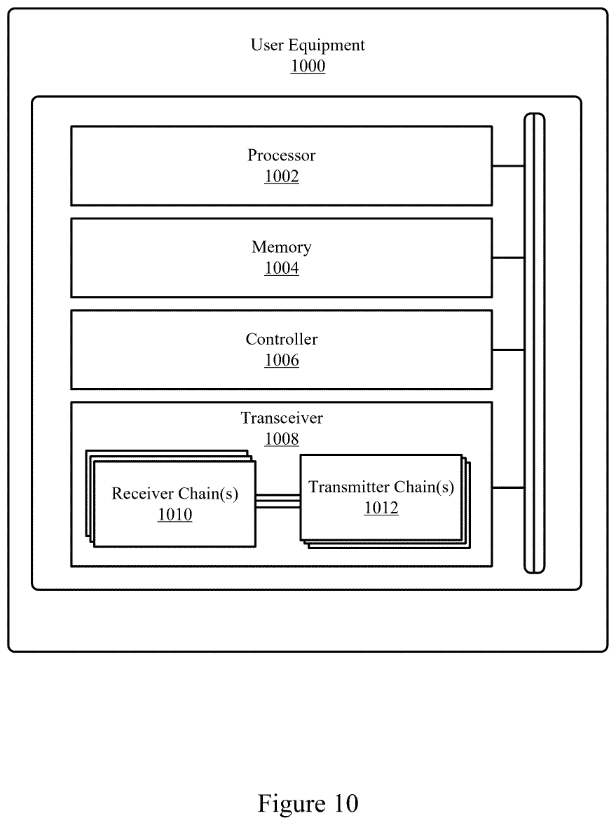

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field-programmable gate-array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions that, when executed by the processor 1002, cause the UE 1000 to perform various functions described herein. The code may be stored in a non-transitory computer-readable medium such as the memory 1004 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving first signaling that indicates a first mapping between a set of SSB indices and a set of virtual identifiers, receiving second signaling that indicates a second mapping between the set of virtual identifiers and a set of ROs, selecting an SSB index of the set of SSB indices, where the SSB index corresponds to a virtual identifier of the set of virtual identifiers based on the first mapping, and transmitting a RACH preamble during an RO of the set of ROs, where the RO corresponds to the virtual identifier based on the second mapping. By implementing the virtual identifier abstraction layer between SSB indices and ROs, the UE 1000 may provide for improved resource utilization, reduced signaling overhead, and enhanced network efficiency during random access procedures by enabling dynamic reallocation of ROs without modifying the SSB-to-virtual-identifier mapping.

Additionally, the UE 1000 may be configured to or operable to support any one or combination of receiving third signaling that suppresses a transmission associated with one or more SSB indices of the set of SSB indices, determining one or more first virtual identifiers corresponding to the one or more SSB indices based on the first mapping, determining one or more additional ROs of the set of ROs corresponding to the one or more first virtual identifiers based on the second mapping, and refraining from transmitting the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs. By supporting suppression signaling and deactivation of mappings, the UE 1000 may reduce power consumption and improve resource efficiency by reducing or avoiding transmissions on ROs associated with suppressed SSB indices. Additionally, or alternatively, the UE 1000 may be configured to or operable to support receiving, prior to receiving the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and applying, based on the third signaling, an offset in a time domain to beam groups of the set of beam groups other than the beam group, where the beam groups are associated with contiguous transmission in the time domain based on the offset. By applying time domain offsets to maintain contiguous transmission, the UE 1000 may improve spectral efficiency and reduce latency by consolidating active transmissions.

Additionally, or alternatively, the UE 1000 may be configured to or operable to support the one or more SSB indices are associated with a common spatial region. By associating SSB indices with a common spatial region, the UE 1000 may enable efficient beam management and reduce complexity in spatial direction handling. Additionally, or alternatively, the UE 1000 may be configured to or operable to support the third signaling includes a bitmap with at least one bit indicating to suppress the transmission associated with the beam group. By utilizing a bitmap for suppression indication, the UE 1000 may reduce signaling overhead, while providing flexible and granular control over beam group suppression. Additionally, or alternatively, the UE 1000 may be configured to or operable to support the transmission includes a set of transmission types associated with the beam group, where the set of transmission types includes an SSB transmission type, a RACH transmission type, a system information transmission type, and a paging transmission type, and receiving fifth signaling that indicates respective numerical quantities of time-frequency resources associated with the set of transmission types, where respective transmission types of the set of transmission types are grouped in the time domain based on the respective numerical quantities of the time-frequency resources. By grouping transmission types in the time domain based on resource quantities, the UE 1000 may improve power efficiency and enable coordinated suppression of related transmissions.

Additionally, or alternatively, to select the SSB index, the UE 1000 may be configured to or operable to support performing respective measurements associated with a set of beams, where the set of beams correspond to the set of SSB indices, and determining, based on the respective measurements, that a beam corresponding to the SSB index has a highest quality of the set of beams. By selecting the SSB index based on beam quality measurements, the UE 1000 may improve communication reliability and signal quality for random access procedures. Additionally, or alternatively, the UE 1000 may be configured to or operable to support the first signaling includes first RRC signaling, and the second signaling includes at least one of the first RRC signaling, second RRC signaling, a MAC-CE, a DCI, or a WUS. By enabling the second mapping to be configured via lower-layer signaling, such as MAC-CE, DCI, or WUS, the UE 1000 may support dynamic reallocation of ROs with reduced signaling overhead compared to RRC reconfiguration. Additionally, or alternatively, the UE 1000 may be configured to or operable to support the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. By supporting flexible mappings between SSB indices, virtual identifiers, and ROs, the UE 1000 may enable efficient resource allocation and load balancing across multiple beams. Additionally, or alternatively, the UE 1000 may be configured to or operable to support the virtual identifier includes at least one of a VRO identifier associated with one or more ROs of the set of ROs or a VRO-G identifier associated with two or more ROs of the set of ROs. By supporting both VRO identifiers and VRO-G identifiers, the UE 1000 may provide flexibility in resource allocation granularity and support for RACH preamble repetitions. Additionally, or alternatively, the UE 1000 may be configured to or operable to support the virtual identifier includes the VRO-G identifier, and to transmit the RACH preamble, transmitting a set of repetitions of the RACH preamble on the two or more ROs. By transmitting repetitions of the RACH preamble on multiple ROs associated with a VRO-G identifier, the UE 1000 may improve random access success probability and coverage for UEs in challenging radio conditions.

Additionally, or alternatively, the UE 1000 may support at least one memory (e.g., the memory 1004) and at least one processor (e.g., the processor 1002) coupled with the at least one memory and configured to cause the UE 1000 to receive first signaling that indicates a first mapping between a set of SSB indices and a set of virtual identifiers, receive second signaling that indicates a second mapping between the set of virtual identifiers and a set of ROs, select an SSB index of the set of SSB indices, where the SSB index corresponds to a virtual identifier of the set of virtual identifiers based on the first mapping, and transmit a RACH preamble during an RO of the set of ROs, where the RO corresponds to the virtual identifier based on the second mapping.

Additionally, the UE 1000 may be configured or operable to support any one or combination of to receive third signaling that suppresses a transmission associated with one or more SSB indices of the set of SSB indices, determine one or more first virtual identifiers corresponding to the one or more SSB indices based on the first mapping, determine one or more additional ROs of the set of ROs corresponding to the one or more first virtual identifiers based on the second mapping, and refrain from transmitting the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs. Additionally, or alternatively, the UE 1000 may be configured to or operable to support to receive, prior to receiving the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and apply, based on the third signaling, an offset in a time domain to beam groups of the set of beam groups other than the beam group, where the beam groups are associated with contiguous transmission in the time domain based on the offset. Additionally, or alternatively, the UE 1000 may be configured to or operable to support the one or more SSB indices are associated with a common spatial region. Additionally, or alternatively, the UE 1000 may be configured to or operable to support the third signaling includes a bitmap with at least one bit indicating to suppress the transmission associated with the beam group. Additionally, or alternatively, the UE 1000 may be configured to or operable to support the transmission includes a set of transmission types associated with the beam group, where the set of transmission types includes an SSB transmission type, a RACH transmission type, a system information transmission type, and a paging transmission type, and to receive fifth signaling that indicates respective numerical quantities of time-frequency resources associated with the set of transmission types, where respective transmission types of the set of transmission types are grouped in the time domain based on the respective numerical quantities of the time-frequency resources.

Additionally, or alternatively, to select the SSB index, the UE 1000 may be configured to or operable to support to perform respective measurements associated with a set of beams, where the set of beams correspond to the set of SSB indices, and determine, based on the respective measurements, that a beam corresponding to the SSB index has a highest quality of the set of beams. Additionally, or alternatively, the UE 1000 may be configured to or operable to support the first signaling includes first RRC signaling, and the second signaling includes at least one of the first RRC signaling, second RRC signaling, a MAC-CE, a DCI, or a WUS. Additionally, or alternatively, the UE 1000 may be configured to or operable to support the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. Additionally, or alternatively, the UE 1000 may be configured to or operable to support the virtual identifier includes at least one of a VRO identifier associated with one or more ROs of the set of ROs or a VRO-G identifier associated with two or more ROs of the set of ROs. Additionally, or alternatively, the UE 1000 may be configured to or operable to support the virtual identifier includes the VRO-G identifier, and to transmit the RACH preamble, to transmit a set of repetitions of the RACH preamble on the two or more ROs.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

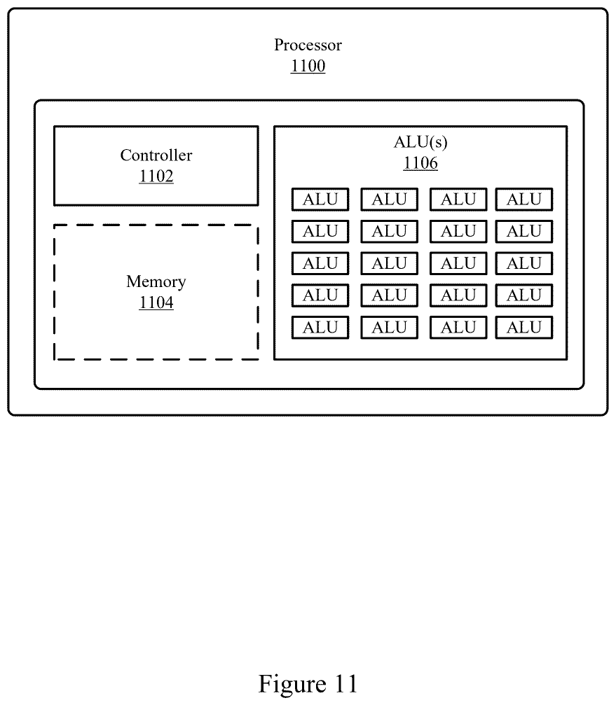

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor 1100 to receive first signaling that indicates a first mapping between a set of SSB indices and a set of virtual identifiers, receive second signaling that indicates a second mapping between the set of virtual identifiers and a set of ROs, select an SSB index of the set of SSB indices, where the SSB index corresponds to a virtual identifier of the set of virtual identifiers based on the first mapping, and transmit a RACH preamble during an RO of the set of ROs, where the RO corresponds to the virtual identifier based on the second mapping. By implementing the virtual identifier abstraction layer between SSB indices and ROs, the processor 1100 enables dynamic reallocation of ROs without modifying the SSB-to-virtual-identifier mapping, thereby improving resource utilization efficiency and reducing signaling overhead during random access procedures.

Additionally, the processor 1100 may be configured to or operable to support any one or combination of to receive third signaling that suppresses a transmission associated with one or more SSB indices of the set of SSB indices, determine one or more first virtual identifiers corresponding to the one or more SSB indices based on the first mapping, determine one or more additional ROs of the set of ROs corresponding to the one or more first virtual identifiers based on the second mapping, and refrain from transmitting the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs. These features enable the processor 1100 to support power-efficient operation by allowing suppression of transmissions in spatial directions with low traffic load, while maintaining efficient resource utilization through dynamic RO reallocation. Additionally, or alternatively, the processor 1100 may be configured to or operable to support to receive, prior to receiving the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and apply, based on the third signaling, an offset in a time domain to beam groups of the set of beam groups other than the beam group, where the beam groups are associated with contiguous transmission in the time domain based on the offset. This configuration enables contiguous transmission scheduling that reduces active duration periods and enhances power savings at both the processor and network equipment.

Additionally, or alternatively, the processor 1100 may be configured to or operable to support the one or more SSB indices are associated with a common spatial region. Associating SSB indices with a common spatial region enables efficient beam group management and coordinated suppression of transmissions for spatially related beams. Additionally, or alternatively, the processor 1100 may be configured to or operable to support the third signaling includes a bitmap with at least one bit indicating to suppress the transmission associated with the beam group. The bitmap-based signaling provides a compact and efficient mechanism for indicating suppression status across multiple beam groups, reducing signaling overhead. Additionally, or alternatively, the processor 1100 may be configured to or operable to support the transmission includes a set of transmission types associated with the beam group, where the set of transmission types includes an SSB transmission type, a RACH transmission type, a system information transmission type, and a paging transmission type, and to receive fifth signaling that indicates respective numerical quantities of time-frequency resources associated with the set of transmission types, where respective transmission types of the set of transmission types are grouped in the time domain based on the respective numerical quantities of the time-frequency resources. Grouping transmission types in the time domain based on resource quantities improves scheduling and extends inactive durations for improved power efficiency.

Additionally, or alternatively, to select the SSB index, the processor 1100 may be configured to or operable to support to perform respective measurements associated with a set of beams, where the set of beams correspond to the set of SSB indices, and determine, based on the respective measurements, that a beam corresponding to the SSB index has a highest quality of the set of beams. Selecting the SSB index based on beam quality measurements improves beam selection for RACH preamble transmission, improving random access success rates. Additionally, or alternatively, the processor 1100 may be configured to or operable to support the first signaling includes first RRC signaling, and the second signaling includes at least one of the first RRC signaling, second RRC signaling, a MAC-CE, a DCI, or a WUS. Supporting multiple signaling types for the second mapping enables flexible and dynamic reconfiguration of virtual identifier to RO mappings with reduced latency compared to RRC signaling. Additionally, or alternatively, the processor 1100 may be configured to or operable to support the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. The two-level mapping structure provides flexibility in associating multiple SSB indices with virtual identifiers and multiple ROs with virtual identifiers, enabling efficient resource management. Additionally, or alternatively, the processor 1100 may be configured to or operable to support the virtual identifier includes at least one of a VRO identifier associated with one or more ROs of the set of ROs or a VRO-G identifier associated with two or more ROs of the set of ROs. Supporting both VRO and VRO-G identifiers enables flexible resource allocation for both single RO transmissions and multi-RO repetition scenarios. Additionally, or alternatively, the processor 1100 may be configured to or operable to support the virtual identifier includes the VRO-G identifier, and to transmit the RACH preamble, to transmit a set of repetitions of the RACH preamble on the two or more ROs. Transmitting RACH preamble repetitions across multiple ROs associated with a VRO-G identifier improves random access reliability and coverage.

The processor 1100 may be configured to or operable to support at least one controller (e.g., the controller 1102) coupled with at least one memory (e.g., the memory 1104) and configured to cause the processor 1100 to transmit first signaling that indicates a first mapping between a set of SSB indices and a set of virtual identifiers, transmit second signaling that indicates a second mapping between the set of virtual identifiers and a set of ROs, and receive a RACH preamble during an RO of the set of ROs, where the RO corresponds to a virtual identifier of the set of virtual identifiers based on the second mapping, and where the virtual identifier corresponds to an SSB index of the set of SSB indices based on the first mapping. By implementing the virtual identifier abstraction layer, the processor 1100 enables efficient determination of the SSB index associated with a received RACH preamble and supports dynamic RO reallocation without reconfiguring the SSB-to-virtual-identifier mapping, thereby reducing signaling overhead and enhancing network efficiency.

Additionally, the processor 1100 may be configured to or operable to support any one or combination of to determine to suppress a transmission associated with one or more SSB indices of the set of SSB indices, transmit third signaling that suppresses the transmission associated with the one or more SSB indices, determine one or more first virtual identifiers corresponding to the one or more SSB indices based on the first mapping, determine one or more additional ROs of the set of ROs corresponding to the one or more first virtual identifiers based on the second mapping, and refrain from monitoring for the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs. These features enable the processor 1100 to reduce power consumption by suppressing transmissions and monitoring in spatial directions with low traffic load, while dynamically reallocating unused ROs to active beam groups. Additionally, or alternatively, the processor 1100 may be configured to or operable to support to transmit, prior to transmitting the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and apply, based on the third signaling, an offset in a time domain to beam groups of the set of beam groups other than the beam group, where the beam groups are associated with contiguous transmission in the time domain based on the offset. This configuration enables contiguous transmission scheduling that maximizes inactive durations for power savings, while maintaining efficient beam group management.

Additionally, or alternatively, the processor 1100 may be configured to or operable to support the one or more SSB indices are associated with a common spatial region. Associating SSB indices with a common spatial region enables coordinated suppression and activation of transmissions for spatially related beams, improving network efficiency. Additionally, or alternatively, the processor 1100 may be configured to or operable to support the third signaling includes a bitmap with at least one bit indicating to suppress the transmission associated with the beam group. The bitmap-based signaling provides an efficient and compact mechanism for communicating suppression status across multiple beam groups with reduced signaling overhead. Additionally, or alternatively, to determine to suppress the transmission, the processor 1100 may be configured to or operable to support to determine, for the set of beam groups and over a measurement window, respective RACH loads including a numerical quantity of RACH preambles in a numerical quantity of available ROs, where the transmission is suppressed for the beam group based on a RACH load of the respective RACH loads associated with the beam group satisfying a threshold value. Load-based suppression determination enables adaptive power management by suppressing transmissions for beam groups with low traffic demand, while maintaining service for active beam groups.

Additionally, or alternatively, the processor 1100 may be configured to or operable to support to receive, from a UE associated with a spatial direction covered by the beam group, an additional RACH preamble on an additional beam group, and cancel suppression of the transmission for the beam group based on the additional RACH preamble. This feature enables responsive reactivation of suppressed beam groups when UE demand is detected, ensuring service availability while maintaining power efficiency. Additionally, or alternatively, the processor 1100 may be configured to or operable to support to transmit, based on a periodicity, fifth signaling on an additional beam group associated with a spatial direction covered by the beam group, receive, in response to the fifth signaling, an additional RACH preamble, and cancel suppression of the transmission for the beam group based on the additional RACH preamble. Periodic signaling for suppressed beam groups enables proactive detection of UE presence and timely reactivation of beam groups, balancing power savings with service responsiveness. Additionally, or alternatively, the processor 1100 may be configured to or operable to support to determine, based on the RO and the second mapping, the virtual identifier corresponding to the RO, determine, based on the virtual identifier and the first mapping, the SSB index corresponding to the virtual identifier, and transmit a RAR on a beam corresponding to the SSB index. The two-stage mapping lookup enables accurate beam determination for RAR transmission, ensuring beam alignment between the NE and UE during random access procedures. Additionally, or alternatively, the processor 1100 may be configured to or operable to support the first signaling includes first RRC signaling, and the second signaling includes at least one of the first RRC signaling, second RRC signaling, a MAC-CE, a DCI, or a WUS. Supporting multiple signaling types for the second mapping enables flexible and low-latency reconfiguration of virtual identifier to RO mappings compared to RRC approaches.

Additionally, or alternatively, the processor 1100 may be configured to or operable to support the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. The two-level mapping structure provides flexibility in resource allocation and enables efficient management of SSB-to-RO associations through the virtual identifier abstraction layer. Additionally, or alternatively, the processor 1100 may be configured to or operable to support the virtual identifier includes at least one of a VRO identifier associated with one or more ROs of the set of ROs or a VRO-G identifier associated with two or more ROs of the set of ROs. Supporting both VRO and VRO-G identifiers enables flexible resource allocation for diverse random access scenarios, including single RO and multi-RO repetition configurations. Additionally, or alternatively, the processor 1100 may be configured to or operable to support the virtual identifier includes the VRO-G identifier, and to receive the RACH preamble, to receive a set of repetitions of the RACH preamble on the two or more ROs. Receiving RACH preamble repetitions across multiple ROs associated with a VRO-G identifier improves detection reliability and extends coverage for UEs.

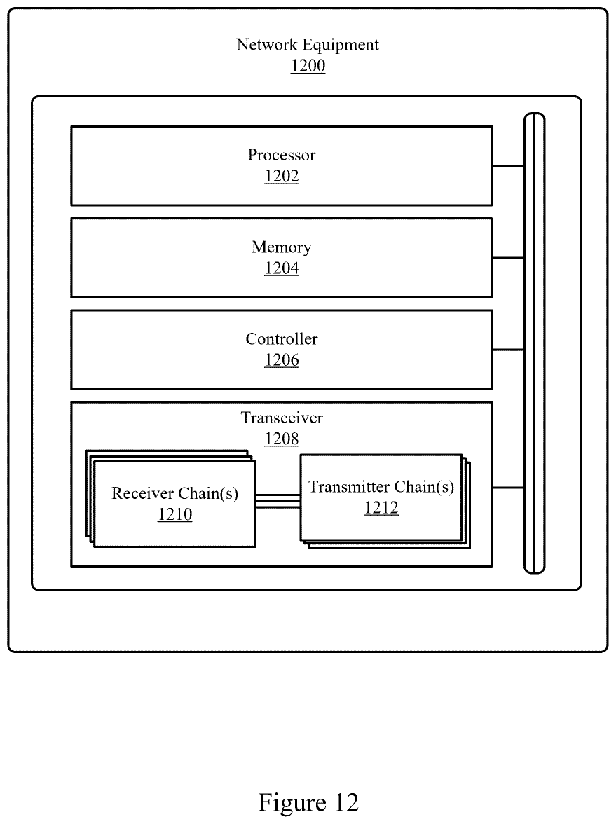

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a DSP, an ASIC, or other programmable logic device, or any combination thereof, configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions that, when executed by the processor 1202, cause the NE 1200 to perform various functions described herein. The code may be stored in a non-transitory computer-readable medium, such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting first signaling that indicates a first mapping between a set of SSB indices and a set of virtual identifiers, transmitting second signaling that indicates a second mapping between the set of virtual identifiers and a set of ROs, and receiving a RACH preamble during an RO of the set of ROs, where the RO corresponds to a virtual identifier of the set of virtual identifiers based on the second mapping, and where the virtual identifier corresponds to an SSB index of the set of SSB indices based on the first mapping. By implementing the virtual identifier abstraction layer between SSB indices and ROs, the NE 1200 enables dynamic reallocation of ROs without modifying the SSB-to-virtual-identifier mapping, thereby improving resource utilization efficiency and reducing signaling overhead during random access procedures.

Additionally, the NE 1200 may be configured to or operable to support any one or combination of to determine to suppress a transmission associated with one or more SSB indices of the set of SSB indices, transmit third signaling that suppresses the transmission associated with the one or more SSB indices, determine one or more first virtual identifiers corresponding to the one or more SSB indices based on the first mapping, determine one or more additional ROs of the set of ROs corresponding to the one or more first virtual identifiers based on the second mapping, and refrain from monitoring for the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs. This configuration enables the NE 1200 to reduce power consumption by suppressing transmissions in spatial directions with low traffic load, while dynamically reallocating unused ROs to active SSBs and beam groups. Additionally, or alternatively, the NE 1200 may be configured to or operable to support to transmit, prior to transmitting the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and apply, based on the third signaling, an offset in a time domain to beam groups of the set of beam groups other than the beam group, where the beam groups are associated with contiguous transmission in the time domain based on the offset. This configuration enables efficient beam group management and contiguous transmission scheduling, thereby reducing latency and improving spectral efficiency.

Additionally, or alternatively, the NE 1200 may be configured to or operable to support the one or more SSB indices are associated with a common spatial region. This association enables coordinated suppression of transmissions for SSB indices covering the same spatial area, thereby maximizing power savings when traffic load is low in a spatial direction. Additionally, or alternatively, the NE 1200 may be configured to or operable to support the third signaling includes a bitmap with at least one bit indicating to suppress the transmission associated with the beam group. The bitmap-based signaling provides a compact and efficient mechanism for indicating suppression of multiple beam groups, thereby reducing signaling overhead. Additionally, or alternatively, to determine to suppress the transmission, the NE 1200 may be configured to or operable to support to determine, for the set of beam groups and over a measurement window, respective RACH loads including a numerical quantity of RACH preambles in a numerical quantity of available ROs, where the transmission is suppressed for the beam group based on a RACH load of the respective RACH loads associated with the beam group satisfying a threshold value. The load-based determination enables adaptive suppression of transmissions based on traffic conditions, thereby improving power consumption, while maintaining service availability.

Additionally, or alternatively, the NE 1200 may be configured to or operable to support to receive, from a UE associated with a spatial direction covered by the beam group, an additional RACH preamble on an additional beam group, and cancel suppression of the transmission for the beam group based on the additional RACH preamble. This configuration enables responsive reactivation of suppressed beam groups when UE demand increases, thereby ensuring service continuity for UEs entering previously suppressed spatial regions. Additionally, or alternatively, the NE 1200 may be configured to or operable to support to transmit, based on a periodicity, fifth signaling on an additional beam group associated with a spatial direction covered by the beam group, receive, in response to the fifth signaling, an additional RACH preamble, and cancel suppression of the transmission for the beam group based on the additional RACH preamble. This periodic signaling mechanism enables the NE 1200 to detect UE presence in suppressed spatial regions and restore service, thereby balancing power savings with service availability. Additionally, or alternatively, the NE 1200 may be configured to or operable to support the transmission includes a set of transmission types associated with the beam group, where the set of transmission types includes an SSB transmission type, a RACH transmission type, a system information transmission type, and a paging transmission type, and to transmit fifth signaling that indicates respective numerical quantities of time-frequency resources associated with the set of transmission types, where respective transmission types of the set of transmission types are grouped in the time domain based on the respective numerical quantities of the time-frequency resources. This grouping of transmission types enables efficient clustering of common channel resources, thereby reducing active duration and maximizing power savings during inactive periods.

Additionally, or alternatively, the NE 1200 may be configured to or operable to support to determine, based on the RO and the second mapping, the virtual identifier corresponding to the RO, determine, based on the virtual identifier and the first mapping, the SSB index corresponding to the virtual identifier, and transmit a RAR on a beam corresponding to the SSB index. This reverse mapping capability enables the NE 1200 to accurately identify the appropriate beam for RAR transmission, thereby ensuring reliable completion of the random access procedure. Additionally, or alternatively, the NE 1200 may be configured to or operable to support the first signaling includes first RRC signaling, and the second signaling includes at least one of the first RRC signaling, second RRC signaling, a MAC-CE, a DCI, or a WUS. This flexible signaling configuration enables the NE 1200 to dynamically update the virtual identifier to RO mapping using lower-layer signaling, thereby reducing reconfiguration latency compared to RRC-based updates.

Additionally, or alternatively, the NE 1200 may be configured to or operable to support the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. This mapping capability provides flexibility in resource allocation, enabling efficient utilization of ROs across multiple SSB indices. Additionally, or alternatively, the NE 1200 may be configured to or operable to support the virtual identifier includes at least one of a VRO identifier associated with one or more ROs of the set of ROs or a VRO-G identifier associated with two or more ROs of the set of ROs. The dual identifier structure enables both individual RO addressing and grouped RO addressing, thereby supporting diverse random access configurations. Additionally, or alternatively, the NE 1200 may be configured to or operable to support the virtual identifier includes the VRO-G identifier, and to receive the RACH preamble, to receive a set of repetitions of the RACH preamble on the two or more ROs. The repetition capability enhances RACH preamble detection reliability, thereby improving random access success rates in challenging channel conditions.

Additionally, or alternatively, the NE 1200 may support at least one memory (e.g., the memory 1204) and at least one processor (e.g., the processor 1202) coupled with the at least one memory and configured to cause the NE to transmit first signaling that indicates a first mapping between a set of SSB indices and a set of virtual identifiers, transmit second signaling that indicates a second mapping between the set of virtual identifiers and a set of ROs, and receive a RACH preamble during an RO of the set of ROs, where the RO corresponds to a virtual identifier of the set of virtual identifiers based on the second mapping, and where the virtual identifier corresponds to an SSB index of the set of SSB indices based on the first mapping.

Additionally, the NE 1200 may be configured to or operable to support any one or combination of to determine to suppress a transmission associated with one or more SSB indices of the set of SSB indices, transmit third signaling that suppresses the transmission associated with the one or more SSB indices, determine one or more first virtual identifiers corresponding to the one or more SSB indices based on the first mapping, determine one or more additional ROs of the set of ROs corresponding to the one or more first virtual identifiers based on the second mapping, and refrain from monitoring for the RACH preamble during the one or more additional ROs based on the third signaling, where the one or more additional ROs are associated with one or more second virtual identifiers based on the third signaling triggering deactivation of the second mapping between the one or more first virtual identifiers and the one or more additional ROs of the set of ROs. Additionally, or alternatively, the NE 1200 may be configured to support to transmit, prior to transmitting the third signaling, fourth signaling that indicates one or more of a third mapping between the set of SSB indices and a set of beam groups, respective ROs associated with the set of beam groups, preamble partitioning within respective beam groups of the set of beam groups, or transmit beam sweeping support associated with the respective beam groups, where a beam group of the set of beam groups includes one or more beams associated with the one or more SSB indices, and apply, based on the third signaling, an offset in a time domain to beam groups of the set of beam groups other than the beam group, where the beam groups are associated with contiguous transmission in the time domain based on the offset.

Additionally, or alternatively, the NE 1200 may be configured to support the one or more SSB indices are associated with a common spatial region. Additionally, or alternatively, the NE 1200 may be configured to support the third signaling includes a bitmap with at least one bit indicating to suppress the transmission associated with the beam group. Additionally, or alternatively, to determine to suppress the transmission, the NE 1200 may be configured to support to determine, for the set of beam groups and over a measurement window, respective RACH loads including a numerical quantity of RACH preambles in a numerical quantity of available ROs, where the transmission is suppressed for the beam group based on a RACH load of the respective RACH loads associated with the beam group satisfying a threshold value. Additionally, or alternatively, the NE 1200 may be configured to support to receive, from a UE associated with a spatial direction covered by the beam group, an additional RACH preamble on an additional beam group, and cancel suppression of the transmission for the beam group based on the additional RACH preamble. Additionally, or alternatively, the NE 1200 may be configured to support to transmit, based on a periodicity, fifth signaling on an additional beam group associated with a spatial direction covered by the beam group, receive, in response to the fifth signaling, an additional RACH preamble, and cancel suppression of the transmission for the beam group based on the additional RACH preamble. Additionally, or alternatively, the NE 1200 may be configured to support the transmission includes a set of transmission types associated with the beam group, where the set of transmission types includes an SSB transmission type, a RACH transmission type, a system information transmission type, and a paging transmission type, and to transmit fifth signaling that indicates respective numerical quantities of time-frequency resources associated with the set of transmission types, where respective transmission types of the set of transmission types are grouped in the time domain based on the respective numerical quantities of the time-frequency resources.

Additionally, or alternatively, the NE 1200 may be configured to support to determine, based on the RO and the second mapping, the virtual identifier corresponding to the RO, determine, based on the virtual identifier and the first mapping, the SSB index corresponding to the virtual identifier, and transmit a RAR on a beam corresponding to the SSB index. Additionally, or alternatively, the NE 1200 may be configured to support the first signaling includes first RRC signaling, and the second signaling includes at least one of the first RRC signaling, second RRC signaling, a MAC-CE, a DCI, or a WUS. Additionally, or alternatively, the NE 1200 may be configured to support the first mapping indicates that respective SSB indices of the set of SSB indices are associated with one or more respective virtual identifiers of the set of virtual identifiers, and the second mapping indicates that respective virtual identifiers of the set of virtual identifiers are associated with one or more ROs of the set of ROs. Additionally, or alternatively, the NE 1200 may be configured to support the virtual identifier includes at least one of a VRO identifier associated with one or more ROs of the set of ROs or a VRO-G identifier associated with two or more ROs of the set of ROs. Additionally, or alternatively, the NE 1200 may be configured to support the virtual identifier includes the VRO-G identifier, and to receive the RACH preamble, to receive a set of repetitions of the RACH preamble on the two or more ROs.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., an LNA) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

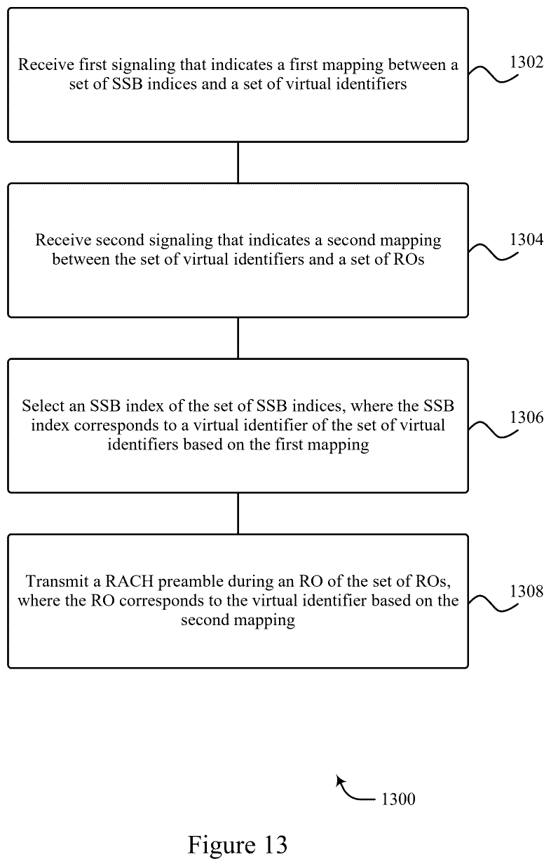

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving first signaling that indicates a first mapping between a set of SSB indices and a set of virtual identifiers. The operations of 1302 may be performed in accordance with examples as described herein. In some implementations, aspects of the operations of 1302 may be performed by a UE as described with reference to FIG. 10.

At 1304, the method may include receiving second signaling that indicates a second mapping between the set of virtual identifiers and a set of ROs. The operations of 1304 may be performed in accordance with examples as described herein. In some implementations, aspects of the operations of 1304 may be performed by a UE as described with reference to FIG. 10.

At 1306, the method may include selecting an SSB index of the set of SSB indices, where the SSB index corresponds to a virtual identifier of the set of virtual identifiers based on the first mapping. The operations of 1306 may be performed in accordance with examples as described herein. In some implementations, aspects of the operations of 1306 may be performed by a UE as described with reference to FIG. 10.

At 1308, the method may include transmitting a RACH preamble during an RO of the set of ROs, where the RO corresponds to the virtual identifier based on the second mapping. The operations of 1308 may be performed in accordance with examples as described herein. In some implementations, aspects of the operations of 1308 may be performed by a UE as described with reference to FIG. 10.

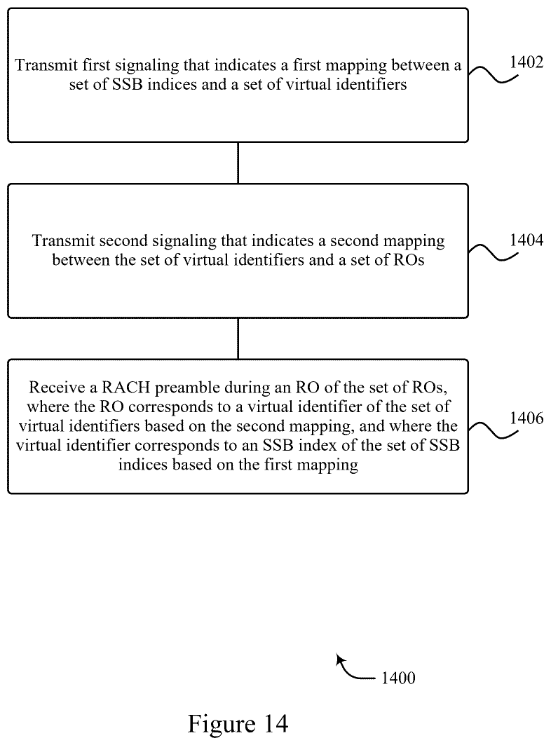

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting first signaling that indicates a first mapping between a set of SSB indices and a set of virtual identifiers. The operations of 1402 may be performed in accordance with examples as described herein. In some implementations, aspects of the operations of 1402 may be performed by an NE as described with reference to FIG. 12.

At 1404, the method may include transmitting second signaling that indicates a second mapping between the set of virtual identifiers and a set of ROs. The operations of 1404 may be performed in accordance with examples as described herein. In some implementations, aspects of the operations of 1404 may be performed by an NE as described with reference to FIG. 12.

At 1406, the method may include receiving a RACH preamble during an RO of the set of ROs, where the RO corresponds to a virtual identifier of the set of virtual identifiers based on the second mapping, and where the virtual identifier corresponds to an SSB index of the set of SSB indices based on the first mapping. The operations of 1406 may be performed in accordance with examples as described herein. In some implementations, aspects of the operations of 1406 may be performed by an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive first signaling that indicates a first mapping between a plurality of synchronization signal block (SSB) indices and a plurality of virtual identifiers;
receive second signaling that indicates a second mapping between the plurality of virtual identifiers and a plurality of random access channel (RACH) occasions (ROs);
select an SSB index of the plurality of SSB indices, wherein the SSB index corresponds to a virtual identifier of the plurality of virtual identifiers based at least in part on the first mapping; and
transmit a RACH preamble during an RO of the plurality of ROs, wherein the RO corresponds to the virtual identifier based at least in part on the second mapping.

2. The UE of claim 1, wherein the at least one processor is further operable to cause the UE to:
receive third signaling that suppresses a transmission associated with one or more SSB indices of the plurality of SSB indices;
determine one or more first virtual identifiers corresponding to the one or more SSB indices based at least in part on the first mapping;
determine one or more additional ROs of the plurality of ROs corresponding to the one or more first virtual identifiers based at least in part on the second mapping; and
refrain from transmitting the RACH preamble during the one or more additional ROs based at least in part on the third signaling, wherein the one or more additional ROs are associated with one or more second virtual identifiers based at least in part on the third signaling triggering deactivation of the second mapping between the one or more first virtual identifiers and the one or more additional ROs of the plurality of ROs.

3. The UE of claim 2, wherein the at least one processor is further operable to cause the UE to:
receive, prior to receiving the third signaling, fourth signaling that indicates one or more of a third mapping between the plurality of SSB indices and a plurality of beam groups, respective ROs associated with the plurality of beam groups, preamble partitioning within respective beam groups of the plurality of beam groups, or transmit beam sweeping support associated with the respective beam groups, wherein a beam group of the plurality of beam groups comprises one or more beams associated with the one or more SSB indices; and
apply, based at least in part on the third signaling, an offset in a time domain to beam groups of the plurality of beam groups other than the beam group, wherein the beam groups are associated with contiguous transmission in the time domain based at least in part on the offset.

4. The UE of claim 3, wherein the one or more SSB indices are associated with a common spatial region.

5. The UE of claim 3, wherein the third signaling comprises a bitmap with at least one bit indicating to suppress the transmission associated with the beam group.

6. The UE of claim 3, wherein the transmission comprises a plurality of transmission types associated with the beam group, wherein the plurality of transmission types comprises an SSB transmission type, a RACH transmission type, a system information transmission type, and a paging transmission type, and wherein the at least one processor is further operable to cause the UE to:
receive fifth signaling that indicates respective numerical quantities of time-frequency resources associated with the plurality of transmission types, wherein respective transmission types of the plurality of transmission types are grouped in the time domain based at least in part on the respective numerical quantities of the time-frequency resources.

7. The UE of claim 1, wherein to select the SSB index, the at least one processor is operable to cause the UE to:
perform respective measurements associated with a plurality of beams, wherein the plurality of beams correspond to the plurality of SSB indices; and
determine, based at least in part on the respective measurements, that a beam corresponding to the SSB index has a highest quality of the plurality of beams.

8. The UE of claim 1, wherein the first signaling comprises first radio resource control (RRC) signaling, and wherein the second signaling comprises at least one of the first RRC signaling, second RRC signaling, a medium access control-control element (MAC-CE), a downlink control information (DCI), or a wake-up signal (WUS).

9. The UE of claim 1, wherein the first mapping indicates that respective SSB indices of the plurality of SSB indices are associated with one or more respective virtual identifiers of the plurality of virtual identifiers, and wherein the second mapping indicates that respective virtual identifiers of the plurality of virtual identifiers are associated with one or more ROs of the plurality of ROs.

10. The UE of claim 1, wherein the virtual identifier comprises at least one of a virtual RACH occasion (VRO) identifier associated with one or more ROs of the plurality of ROs or a VRO-group (VRO-G) identifier associated with two or more ROs of the plurality of ROs.

11. The UE of claim 10, wherein the virtual identifier comprises the VRO-G identifier, and wherein to transmit the RACH preamble, the at least one processor is further operable to cause the UE to transmit a plurality of repetitions of the RACH preamble on the two or more ROs.

12. A method performed by a user equipment (UE), the method comprising:
receiving first signaling that indicates a first mapping between a plurality of synchronization signal block (SSB) indices and a plurality of virtual identifiers;
receiving second signaling that indicates a second mapping between the plurality of virtual identifiers and a plurality of random access channel (RACH) occasions (ROs);
selecting an SSB index of the plurality of SSB indices, wherein the SSB index corresponds to a virtual identifier of the plurality of virtual identifiers based at least in part on the first mapping; and
transmitting a RACH preamble during an RO of the plurality of ROs, wherein the RO corresponds to the virtual identifier based at least in part on the second mapping.

13. A network equipment (NE) for wireless communication, comprising:
at least one memory; and
at least one processor coupled with the at least one memory and operable to cause the NE to:
transmit first signaling that indicates a first mapping between a plurality of synchronization signal block (SSB) indices and a plurality of virtual identifiers;
transmit second signaling that indicates a second mapping between the plurality of virtual identifiers and a plurality of random access channel (RACH) occasions (ROs); and
receive a RACH preamble during an RO of the plurality of ROs, wherein the RO corresponds to a virtual identifier of the plurality of virtual identifiers based at least in part on the second mapping, and wherein the virtual identifier corresponds to an SSB index of the plurality of SSB indices based at least in part on the first mapping.

14. The NE of claim 13, wherein the at least one processor is further operable to cause the NE to:
determine to suppress a transmission associated with one or more SSB indices of the plurality of SSB indices;
transmit third signaling that suppresses the transmission associated with the one or more SSB indices;
determine one or more first virtual identifiers corresponding to the one or more SSB indices based at least in part on the first mapping;
determine one or more additional ROs of the plurality of ROs corresponding to the one or more first virtual identifiers based at least in part on the second mapping; and
refrain from monitoring for the RACH preamble during the one or more additional ROs based at least in part on the third signaling, wherein the one or more additional ROs are associated with one or more second virtual identifiers based at least in part on the third signaling triggering deactivation of the second mapping between the one or more first virtual identifiers and the one or more additional ROs of the plurality of ROs.

15. The NE of claim 14, wherein the at least one processor is further operable to cause the NE to:
transmit, prior to transmitting the third signaling, fourth signaling that indicates one or more of a third mapping between the plurality of SSB indices and a plurality of beam groups, respective ROs associated with the plurality of beam groups, preamble partitioning within respective beam groups of the plurality of beam groups, or transmit beam sweeping support associated with the respective beam groups, wherein a beam group of the plurality of beam groups comprises one or more beams associated with the one or more SSB indices; and
apply, based at least in part on the third signaling, an offset in a time domain to beam groups of the plurality of beam groups other than the beam group, wherein the beam groups are associated with contiguous transmission in the time domain based at least in part on the offset.

16. The NE of claim 15, wherein to determine to suppress the transmission, the at least one processor is operable to cause the NE to:
determine, for the plurality of beam groups and over a measurement window, respective RACH loads comprising a numerical quantity of RACH preambles in a numerical quantity of available ROs, wherein the transmission is suppressed for the beam group based at least in part on a RACH load of the respective RACH loads associated with the beam group satisfying a threshold value.

17. The NE of claim 16, wherein the at least one processor is further operable to cause the NE to:
receive, from a UE associated with a spatial direction covered by the beam group, an additional RACH preamble on an additional beam group; and
cancel suppression of the transmission for the beam group based at least in part on the additional RACH preamble.

18. The NE of claim 16, wherein the at least one processor is further operable to cause the NE to:
transmit, based at least in part on a periodicity, fifth signaling on an additional beam group associated with a spatial direction covered by the beam group;
receive, in response to the fifth signaling, an additional RACH preamble; and
cancel suppression of the transmission for the beam group based at least in part on the additional RACH preamble.

19. The NE of claim 13, wherein the at least one processor is further operable to cause the NE to:
determine, based at least in part on the RO and the second mapping, the virtual identifier corresponding to the RO;
determine, based at least in part on the virtual identifier and the first mapping, the SSB index corresponding to the virtual identifier; and
transmit a random access response (RAR) on a beam corresponding to the SSB index.

20. A method performed by a network equipment (NE), the method comprising:
transmitting first signaling that indicates a first mapping between a plurality of synchronization signal block (SSB) indices and a plurality of virtual identifiers;
transmitting second signaling that indicates a second mapping between the plurality of virtual identifiers and a plurality of random access channel (RACH) occasions (ROs); and
receiving a RACH preamble during an RO of the plurality of ROs, wherein the RO corresponds to a virtual identifier of the plurality of virtual identifiers based at least in part on the second mapping, and wherein the virtual identifier corresponds to an SSB index of the plurality of SSB indices based at least in part on the first mapping.
